(19) United States
(12) Patent Application Publication
(10) Pub. No.: US 2024/0084494 A1
(43) Pub. Date: Mar. 14, 2024

(54) WASHING MACHINE

(71) Applicant: SAMSUNG ELECTRONICS CO., LTD., Suwon-si (KR)

(72) Inventors: Yongbin LIM, Suwon-si (KR); Seungoh KIM, Suwon-si (KR); Jihye LEE, Suwon-si (KR); Yurim PARK, Suwon-si (KR)

(73) Assignee: SAMSUNG ELECTRONICS CO., LTD., Suwon-si (KR)

(21) Appl. No.: 18/349,662

(22) Filed: Jul. 10, 2023

Related U.S. Application Data
(63) Continuation of application No. PCT/KR2023/008368, filed on Jun. 16, 2023.

(30) Foreign Application Priority Data
Sep. 8, 2022 (KR) 10-2022-0114540

(51) Int. Cl. D06F 37/30; D06F 21/06; F16H 1/28; F16H 57/00

(52) U.S. Cl. CPC D06F 37/30; D06F 21/06; F16H 1/28; F16H 57/0037

(57) ABSTRACT

A washing machine includes a tub, a drum, a pulsator, a motor assembly, including a rotor, to supply a driving force, a reduction gear module couplable to the rotor of the motor assembly so that a portion of the reduction gear module is rotatable at an angular velocity less than an angular velocity at which the rotor is rotated, a washing shaft couplable to the pulsator and the portion of the reduction gear module so that the pulsator is rotatable at an angular velocity less than the angular velocity at which the rotor is rotated, a spin-drying shaft couplable to the drum, and a coupler configured to be couplable to the spin-drying shaft and the rotor so that the spin-drying shaft is rotatable at the angular velocity at which the rotor is rotated, where the coupler includes a coupler body having a receiving space to receive the reduction gear module.

### CROSS-REFERENCE TO RELATED APPLICATION

This application is a continuation application, under 35 U.S.C. § 111(a), of international application No. PCT/KR2023/008368, filed on Jun. 16, 2023, which claims priority under 35 U. S. C. § 119 to Korean Patent Application No. 10-2022-0114540, filed Sep. 8, 2022, the disclosures of which are incorporated herein by reference in their entireties.

### BACKGROUND

### 1. Field

The disclosure relates to a washing machine, and more particular to a washing machine including a rotating device capable of rotating a drum or a pulsator of the washing machine.

### 2. Description of Related Art

A washing machine is a machine that uses electric power to wash clothes.

In general, the washing machine is classified into a pulsator-type washing machine that performs washing by rotating water and laundry with a pulsator rotatably installed on a bottom inside a water tub, and a drum-type washing machine that performs washing while repeating an operation of rising and dropping laundry by rotating a drum in which the laundry is placed.

The washing machine includes a tub for storing water and a drum rotatably installed inside the tub. A pulsator is installed at the bottom of the drum to form a water flow while rotating. The pulsator rotates in the forward and reverse directions to form a water flow, and the water flow generated by the pulsator stirs and rotates the water and the laundry, thereby washing the laundry.

The washing machine may perform a washing operation and a spin-drying operation. When the washing machine performs the washing operation, only the pulsator between the drum and the pulsator may rotate. This is because it is required to form the water flow. When the washing machine performs the spin-drying operation, the drum and the pulsator may rotate together.

An expensive motor assembly may be used in the washing machine. The washing machine may include a coupler to select a component, which is rotated by one motor assembly, from the drum and the pulsator.

However, even when the coupler is added, it is required to prevent the washing machine from having increased height. When the height of the washing machine increases, it may cause inconvenience to a user.

### SUMMARY

In accordance with an aspect of the disclosure, a washing machine includes a tub, a drum rotatable inside the tub, a pulsator rotatable inside the drum, a motor assembly, including a rotor, to supply a driving force, a reduction gear module couplable to the rotor of the motor assembly so that while at least a portion of the reduction gear module is coupled to the rotor, the portion of the reduction gear module is rotatable at an angular velocity that is less than an angular velocity at which the rotor is rotated based on the driving force of the motor assembly, a washing shaft couplable to the pulsator and couplable to the portion of the reduction gear module so that while the washing shaft is coupled to the pulsator and the portion of the reduction gear module, the pulsator is rotatable at an angular velocity that less than the angular velocity at which the rotor is rotated based on the driving force of the motor assembly, a spin-drying shaft couplable to the drum so that while the spin-drying shaft is coupled to the drum, the drum is rotated, and a coupler couplable to the spin-drying shaft and the rotor so that while the coupler is coupled to the spin-drying shaft and the rotor, the spin-drying shaft is rotatable at the angular velocity at which the rotor is rotated based on the driving force of the motor assembly, where the coupler includes a coupler body including a receiving space to receive the reduction gear module.

The motor assembly may include a mounting space to receive the coupler while the reduction gear module is received in the receiving space of the coupler.

The reduction gear module may be located between the coupler and the rotor.

The washing machine may be configured to perform a washing operation and a spin-drying operation, and the coupler may include a first toothed member to be engaged with the spin-drying shaft in the spin-drying operation of the washing machine, a second toothed member to be engaged with the reduction gear module in the spin-drying operation of the washing machine, and a third toothed member to be engaged with the rotor in the spin-drying operation of the washing machine.

The coupler may be configured to be moved between a first position, in which the third toothed member is spaced apart from the rotor to limit a rotation of the spin-drying shaft while the washing machine performs the washing operation, and a second position, in which the third toothed member is engaged with the rotor to rotate the spin-drying shaft while the washing machine performs the spin-drying operation.

The reduction gear module may include a sun gear couplable to the rotor and configured to be rotated by the rotor, a plurality of pinion gears to be engaged with the sun gear to be rotated around the sun gear, a ring gear to surround the plurality of pinion gears and be engaged with the plurality of pinion gears to be rotated with the plurality of pinion gears, the ring gear including a ring toothed member configured to be engaged with the second toothed member, and a carrier couplable to a rotation axis of each of the plurality of pinion gears, and couplable to the washing shaft to be rotated together with the washing shaft.

The coupler may be couplable to the spin-drying shaft which is couplable to the drum and the ring gear to limit movement of the ring gear while the washing machine performs the washing operation.

While the washing machine performs the spin-drying operation, the coupler may be rotated at a speed at which the rotor is rotated, the ring gear may be rotated with the coupler as the coupler is rotated, and the spin-drying shaft and the washing shaft may be rotated at a same speed at which the ring gear and the carrier.

The second toothed member may be located inside the coupler body to allow the ring gear to be received in the receiving space.

The third toothed member may be positioned outside the coupler body to be engaged with the rotor on an outside of the coupler body while the washing machine performs the spin-drying operation.

The first toothed member may extend along the spin-drying shaft from the coupler body to increase a contact area between the coupler and the spin-drying shaft.

The spin-drying shaft may include a spin-drying toothed member configured to be engaged with the first toothed member, the reduction gear module may include a ring toothed member configured to be engaged with the second toothed member, and the rotor may include a rotor toothed member configured to be engaged with the third toothed member. The spin-drying toothed member may be located closer to the drum than the ring toothed member. The rotor toothed member may be located farther from the drum than the ring toothed member. The coupler may be configured to be at a first position while the washing machine performs the washing operation, the first toothed member is coupled to the spin-drying toothed member, the second toothed member is coupled to the ring toothed member, and the third toothed member is disengaged from the rotor toothed member. The coupler may be configured to be at a second position farther from the drum than while the coupler is at the first position while the washing machine performs the spin-drying operation, the first toothed member is coupled to the spin-drying toothed member, the second toothed member is coupled to the ring toothed member, and the third toothed member is coupled to the rotor toothed member.

The washing machine may further include a solenoid configured to emit a magnetic field. The coupler may include a yoke configured to interact with the magnetic field emitted by the solenoid. The coupler may be configured to be moved between the first position and the second position according to the magnetic field emitted by the solenoid.

The washing machine may further include a permanent magnet positioned adjacent to the solenoid, and configured to, in response to the coupler being in the second position, limit movement of the coupler.

The reduction gear module may include a first gear bearing configured to support the sun gear and the ring gear to allow the sun gear and the ring gear to be rotated independently of each other, and a second gear bearing configured to support the sun gear and the carrier to allow the sun gear and the carrier to be rotated independently of each other.

In accordance with another aspect of the disclosure, a washing machine includes a tub, a drum configured to be rotatably coupled to an inside of the tub, a pulsator configured to be rotatably coupled to an inside of the drum, a motor assembly including a rotor configured to be rotated at a first rotation speed and including a mounting space formed therein, a reduction gear module including a sun gear configured to be rotated by the rotor, a plurality of pinion gears engaged with the sun gear to be rotated around the sun gear, a ring gear externally engaged with the plurality of pinion gears so as to be relatively rotated with the plurality of pinion gears, and a carrier coupled to each of the plurality of pinion gears on a rotation axis of each of the plurality of pinion gears, and configured to be rotated at a second rotation speed less than the first rotation speed, the reduction gear module received in the mounting space, a spin-drying shaft coupled to the drum, a washing shaft coupled to the pulsator and the carrier to allow the pulsator to be rotated at the second rotation speed, and positioned to be received in the spin-drying shaft, and a coupler configured to, in a spin-drying operation, be coupled to the spin-drying shaft, the ring gear and the rotor to allow the pulsator and the drum to be rotated at the first rotation speed.

The coupler may include a coupler body, a first toothed member configured to be coupled to the spin-drying shaft and arranged in an upper portion of the coupler body, a second toothed member configured to be coupled to the ring gear and arranged on an inside of the coupler body, and a third toothed member configured to be coupled to the rotor and arranged in a lower portion of the coupler body.

The coupler may be disengaged from the spin-drying shaft, the ring gear, and the rotor while the washing machine performs a washing operation.

The washing machine may further include a coupler lifting device configured to pivot to press the coupler so as to move the coupler to a position spaced apart from the rotor.

In accordance with another aspect of the disclosure, a washing machine includes a tub, a drum configured to be rotated inside the tub, a pulsator configured to be rotated inside the drum, a motor assembly including a rotor and a mounting space formed therein, a reduction gear module coupled to the rotor to allow at least a portion of the reduction gear module to be rotated at an angular velocity less than an angular velocity of the rotor, and provided to be received in the mounting space of the motor assembly, a washing shaft coupled to the pulsator and the reduction gear module to allow the pulsator to be rotated at an angular velocity less than the angular velocity of the rotor, a spin-drying shaft coupled to the drum, and a coupler configured to be coupled to the spin-drying shaft and the rotor to allow the spin-drying shaft to be rotated at the angular velocity of the rotor, and provided to be received in the mounting space defined in the motor assembly.

Additional aspects of the disclosure will be set forth in part in the description which follows and, in part, will be obvious from the description, or may be learned by practice of the disclosure.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view of a washing machine according to an embodiment of the disclosure;

FIG. 2 is a cross-sectional view of the washing machine shown in FIG. 1 according to an embodiment of the disclosure;

FIG. 3 is a perspective view of a rotating device of the washing machine shown in FIG. 2 according to an embodiment of the disclosure;

FIG. 4 is an exploded view of the rotating device of the washing machine shown in FIG. 3 according to an embodiment of the disclosure;

FIG. 5 is a cross-sectional view of a shaft assembly of the washing machine shown in FIG. 4 according to an embodiment of the disclosure;

FIG. 6 is an exploded view of a reduction gear module of the washing machine shown in FIG. 4 according to an embodiment of the disclosure;

FIG. 7 is a cross-sectional view of the reduction gear module of the washing machine shown in FIG. 4 according to an embodiment of the disclosure;

FIG. 8 is a perspective view of a coupler of the washing machine shown in FIG. 4 according to an embodiment of the disclosure;

FIG. 9 is a perspective view of the coupler of the washing machine shown in FIG. 8 when viewed from another angle according to an embodiment of the disclosure;

FIG. 10 is a cross-sectional view of the coupler of the washing machine shown in FIG. 8 according to an embodiment of the disclosure;

FIG. 11 is an exploded view of a configuration related to a washing operation or a spin-drying operation among configurations of the washing machine shown in FIG. 4 according to an embodiment of the disclosure;

FIG. 12 is a cross-sectional view illustrating a state in which configurations of washing machine shown in FIG. 11 are coupled according to an embodiment of the disclosure;

FIG. 13 is a cross-sectional view illustrating the rotating device of the washing machine shown in FIG. 3 according to an embodiment of the disclosure;

FIG. 14 is an enlarged cross-sectional view of a portion of the rotating device when the washing machine shown in FIG. 13 is in the washing operation according to an embodiment of the disclosure;

FIG. 15 is a cross-sectional perspective view of the rotating device of the washing machine shown in FIG. 14 according to an embodiment of the disclosure;

FIG. 16 is a cross-sectional view of the rotating device of the washing machine shown in FIG. 14 according to an embodiment of the disclosure;

FIG. 17 is an enlarged cross-sectional view of a portion of the rotating device when the washing machine shown in FIG. 13 is in the spin-drying operation according to an embodiment of the disclosure;

FIG. 18 is a cross-sectional perspective view of the rotating device of the washing machine shown in FIG. 17 according to an embodiment of the disclosure;

FIG. 19 is a cross-sectional view of the rotating device of the washing machine shown in FIG. 13 according to an embodiment of the disclosure;

FIG. 20 is a cross-sectional view illustrating the rotating device of the washing machine shown in FIG. 2 and a peripheral configuration thereof according to an embodiment of the disclosure;

FIG. 21 is a flow chart illustrating a state in which the coupler of the washing machine shown in FIG. 4 is controlled in the washing operation or the spin-drying operation according to an embodiment of the disclosure;

FIG. 22 is a cross-sectional view of a washing machine according to an embodiment of the disclosure;

FIG. 23 is a cross-sectional view of a washing machine according to an embodiment of the disclosure;

FIG. 24 is a perspective view illustrating a lever module of a washing machine according to an embodiment of the disclosure; and

FIG. 25 is a cross-sectional view illustrating a rotating device of a washing machine according to an embodiment of the disclosure.

### DETAILED DESCRIPTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless they are definitely different in a context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, elements, or combinations thereof, but do not preclude the presence or addition of one or more of the features, elements, steps, operations, elements, elements, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

In the following detailed description, the terms of “up and down direction”, “lower side”, “front and rear direction” and the like may be defined by the drawings, but the shape and the location of the component is not limited by the term.

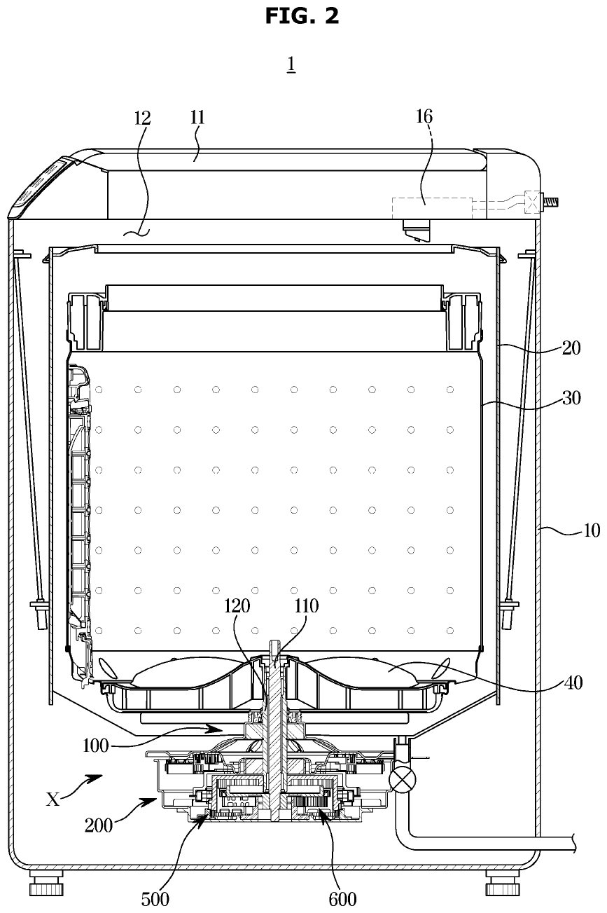

Particularly, as shown in FIG. 2, a direction, in which an opening of a washing machine 1 is opened, is defined as an upper side, and a lower side, left and right sides, and front and rear sides are defined based on this direction.

Therefore, it is an aspect of the disclosure to provide a washing machine capable of preventing an increase in a height thereof.

It is another aspect of the disclosure to provide a washing machine capable of, when the washing machine performs a washing operation, allowing a washing shaft to be rotated at a speed required for the washing operation even though a motor assembly is rotated at an optimal rotation speed.

It is another aspect of the disclosure to provide a washing machine capable of preventing an increase in a height thereof even when a coupler and a reduction gear module are located inside a motor assembly.

It is another aspect of the disclosure to provide a washing machine including a coupler capable of smoothly switching between a washing operation and a spin-drying operation.

It is another aspect of the disclosure to provide a washing machine capable of, when the washing machine performs a spin-drying operation, allowing a washing shaft to be rotated at the same speed as a spin-drying shaft although the washing machine includes a reduction gear module.

It is another aspect of the disclosure to provide a washing machine including a configuration capable of allowing a coupler to be moved.

Reference will now be made in detail to embodiments of the disclosure, examples of which are illustrated in the accompanying drawings.

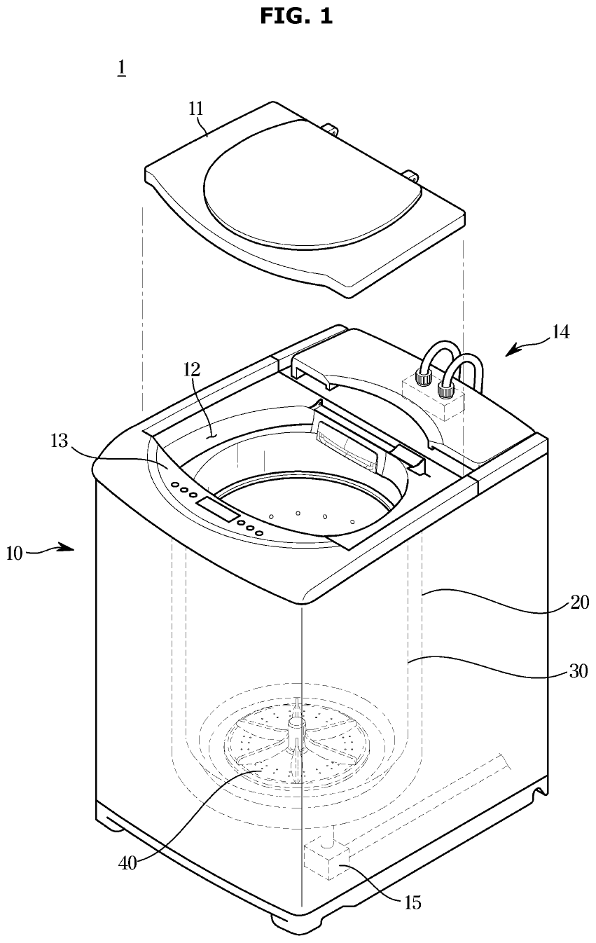

FIG. 1 is a perspective view of the washing machine 1 according to an embodiment of the disclosure. FIG. 2 is a cross-sectional view of the washing machine 1 shown in FIG. 1.

The washing machine 1 will be described with reference to FIGS. 1 and 2.

The washing machine 1 may be a device for washing clothes.

As illustrated in FIG. 1, the washing machine 1 according to an embodiment of the disclosure includes a cabinet 10 forming an exterior, a tub 20 installed inside the cabinet 10 and provided to store water, and a drum 30 rotatably installed inside the tub 20.

In addition, the washing machine 1 includes a water supplier 14 for supplying water into the cabinet 10, and a detergent supply device 16 provided to store detergent, and to mix water supplied from the water supplier 14 with detergent and supply the mixed water to the tub 20.

An inlet 12 for inserting and withdrawing laundry is formed on an upper portion of the cabinet 10, and an upper cover 11 configured to be opened and closed is installed in the inlet 12. A control panel 13 including a plurality of control buttons provided to allow a user to control an operation of the washing machine and a display for displaying an operating state is installed in an upper front portion of the cabinet 10.

The tub 20 for storing water and the drum 30 configured to be rotated inside the tub 20 are installed inside the cabinet 10, and a pulsator 40 configured to form a water flow is installed in an inner lower part of the drum 30.

A rotating device X configured to drive the drum 30 and the pulsator 40, and a drain device 15 configured to drain water are provided below the tub 20 inside the cabinet 10.

After the tub 20 is filled with water containing detergent and laundry is stored inside the drum 30, the washing machine 1 may perform washing as the pulsator 40 is repeatedly rotated in forward and reverse directions by the rotating device X.

After the washing, the laundry may be rinsed through an operation that is the same as the above-mentioned operation while water is repeatedly supplied and drained. After the rinsing operation, water is drained through the drain device 15. Further, after the draining operation, the drum 30 is rotated at high speed to spin-dry the laundry.

The water supplier 14 may be installed at an upper rear portion of the cabinet 10.

The washing machine 1 may perform a washing operation and a spin-drying operation.

In other words, the drum 30 may be configured to be rotated inside the tub 20.

The pulsator 40 may be configured to be rotated inside the drum 3.

The washing machine 1 may include the rotating device X. The rotating device X may be configured to rotate the pulsator 40 and the drum 30 described below.

The rotating device X may be directly or indirectly coupled to pulsator 40 or drum 30.

The washing machine 1 may include a motor assembly 200. The motor assembly 200 may supply a driving force to rotate the pulsator 40 or the drum 30.

The motor assembly 200 may be directly or indirectly coupled to pulsator 40 or the drum 30.

The motor assembly 200 may be located on the opposite side of an opening of the washing machine 1 provided to allow clothes to be put therein.

The washing machine 1 may include the pulsator 40. The pulsator 40 may form a water flow inside the drum 30 when the washing machine 1 performs the washing operation.

The pulsator 40 may be located inside the drum 30.

The pulsator 40 may be rotatably coupled to the inside of the drum 30. The pulsator 40 may be rotatable independently of the drum 30.

When the washing machine 1 is in the washing operation, the pulsator 40 may be rotated independently of the drum 30 to form a water flow inside the drum 30. The water flow inside the drum 30 may wash clothes received inside the drum 30.

In this case, it is appropriate that the pulsator 40 has a rotation speed of 50 rpm. The pulsator 40 may be rotated by the motor assembly 200.

When the washing machine 1 is in the spin-drying operation, the pulsator 40 may be rotated together with the drum 30 to allow water of clothes to be moved toward an inner surface of the drum 30. The water in the clothes may be discharged to an outside of the drum 30 through a through-hole located on the drum 30.

In this case, it is appropriate that the pulsator 40 or the drum 30 has a rotation speed of 800 rpm. The pulsator 40 or the drum 30 may be rotated by the motor assembly 200.

The washing machine 1 may include the drum 30. The drum 30 may be rotatable when the washing machine 1 performs the spin-drying operation.

The drum 30 may be positioned while supporting the pulsator 40.

The drum 30 may be rotatably coupled to the pulsator 40. The drum 30 may be rotated together with the pulsator 40.

The drum 30 may receive clothes that is washable.

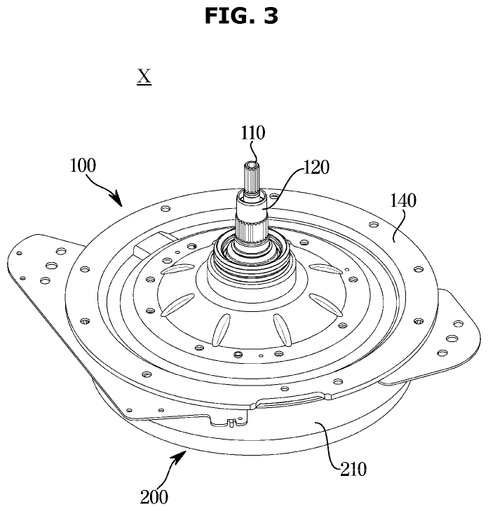

FIG. 3 is a perspective view of the rotating device X of the washing machine 1 shown in FIG. 2.

The rotating device X according to an embodiment of the disclosure will be described with reference to FIG. 3.

The washing machine 1 may include the rotating device X. The rotating device X may be a device that rotates some components of the washing machine 1.

The rotating device X may be configured to rotate the drum 30 (refer to FIG. 2) or the pulsator 40 (refer to FIG. 2).

The rotating device X may include the motor assembly 200. The motor assembly 200 may be configured to obtain a rotational force from electrical energy.

Some components of the motor assembly 200 may be configured to be rotated.

The motor assembly 200 may be indirectly connected to drum 30 or the pulsator 40. However, it is not limited thereto, and the motor assembly 200 may be directly connected to the drum 30 or the pulsator 40.

The motor assembly 200 may be positioned on a lower side of the rotating device X. Accordingly, the motor assembly 200 may support the rotating device X.

The rotating device X may include a shaft assembly 100. The shaft assembly 100 may be a shaft composite coupled to the motor assembly 200.

The shaft assembly 100 may connect the motor assembly 200 to the drum 30 or the pulsator 40. Accordingly, the rotational force of the motor assembly 200 may be transmitted to the drum 30 or the pulsator 40.

The shaft assembly 100 may be connected to the drum 30. The shaft assembly 100 may be connected to the pulsator 40.

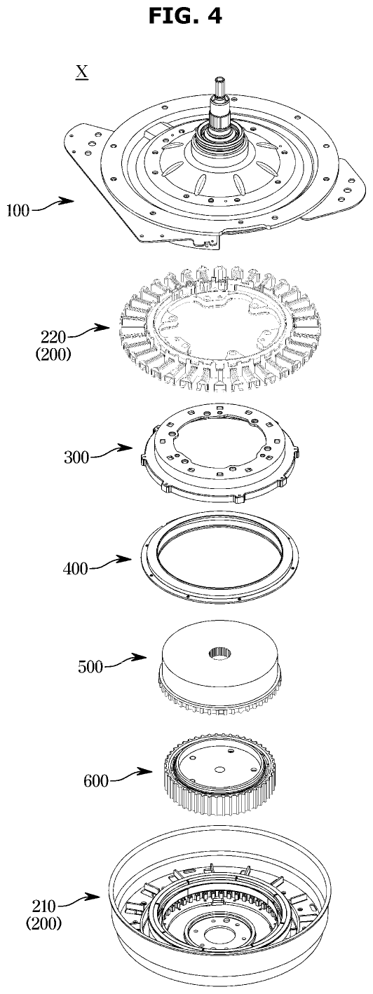

FIG. 4 is an exploded view of the rotating device X of the washing machine 1 shown in FIG. 3.

A configuration of the rotating device X according to an embodiment of the disclosure will be described with reference to FIG. 4.

The rotating device X may include the motor assembly 200.

The motor assembly 200 may include a stator 220 and a rotor 210. The stator 220 may be configured to be fixed in the motor assembly 200. The rotor 210 may be a configuration that is rotated in the motor assembly 200.

The stator 220 may include a coil. A current that periodically changes may flow through the coil. As the current, which flows through the coil, changes periodically, a magnetic field may be formed.

The rotor 210 may include a magnet. The magnet of the rotor 210 may be moved by the magnetic field formed by the current flowing through the coil. This is because the magnet of the rotor 210 receives attractive or repulsive force by interacting with the magnetic field formed by the current flowing through the coil.

The magnet of the rotor 210 may be rotated by the current flowing through the coil. As the magnet of the rotor 210 is rotated, the rotor 210 may be rotatable.

A mounting space 210S may be defined in the rotor 210. The rotor 210 may include the mounting space 210S therein.

The rotor 210 may include the mounting space 210S therein and an opening provided to be received in the mounting space 210S.

The rotor 210 may have a substantially cylindrical shape with one side open.

The rotor 210 may include a metal or a material having magnetism.

The stator 220 may be positioned to be received in the mounting space 210S. As a result, a volume occupied by the stator 220 and the rotor 210 may be reduced.

The stator 220 may be located on an upper side relative to a lower surface of the rotor 210.

The rotating device X may include the shaft assembly 100.

The shaft assembly 100 may be positioned to allow the stator 220 to be positioned between the rotor 210 and the shaft assembly 100. The shaft assembly 100 may be positioned above the rotor 210.

The shaft assembly 100 may be positioned to support stator 220. The shaft assembly 100 may limit an upward-movement of the stator 220.

The shaft assembly 100 may be positioned to cover the opening of the rotor 210. The shaft assembly 100 may prevent foreign substances from being introduced into the rotor 210.

The rotating device X may include a support bracket 300. The support bracket 300 may be configured to support the stator 220.

The support bracket 300 and the shaft assembly 100 may be arranged with the stator 220 interposed therebetween. The support bracket 300 may be located on the lower side of the stator 220. The support bracket 300 may support the stator 220. The support bracket 300 may support the lower side of the stator 220.

The support bracket 300 may have a ring shape. However, it is not limited thereto, and the support bracket 300 may have a shape corresponding to the shape of the stator 220.

The support bracket 300 may include a flat member on the upper side. The flat member on the upper side may be coupled to the shaft assembly 100.

The support bracket 300 may be received in the mounting space 210S defined inside the rotor 210. Accordingly, a volume occupied by the support bracket 300 and the rotor 210 may be reduced.

The support bracket 300 may include a member bending from the flat member on the upper side and extending downward. The support bracket 300 may include a member extending in a radial direction from the member extending downward. The member extending in the radial direction may support the stator 220.

The support bracket 300 may include a member extending downward from the member extending in the radial direction. The member extending downward may cover a coupler lifting device 400 to be described later.

The rotating device X may include the coupler lifting device 400. The coupler lifting device 400 may be configured to lift a coupler 500.

The coupler lifting device 400 may be coupled to the support bracket 300. At least a part of the coupler lifting device 400 may be received in the support bracket 300.

The coupler lifting device 400 may have a ring shape.

The rotating device X may include the coupler 500. The coupler 500 may be configured to connect the rotor 210, a reduction gear module 600, and the shaft assembly 100 to each other.

The coupler 500 may be received in the mounting space 210S defined inside the rotor 210. As a result, a volume occupied by the coupler 500 and the rotor 210 may be reduced.

The coupler 500 may be positioned between the shaft assembly 100 and the rotor 210. The coupler 500 may be positioned below the shaft assembly 100. The coupler 500 may be positioned above the rotor 210.

The coupler 500 may be positioned between the support bracket 300 and the rotor 210. At least a portion of the coupler 500 may be received in the support bracket 300. As a result, a volume occupied by the coupler 500 and the support bracket 300 may be reduced.

The coupler 500 may be positioned below the support bracket 300.

The coupler 500 may be positioned adjacent to the coupler lifting device 400 to allow a position of the coupler 500 to be controlled by the coupler lifting device 400. The coupler 500 may be located inside the coupler lifting device 400.

The coupler 500 may be engaged with the reduction gear module 600.

The coupler 500 may include a plastic material.

The coupler 500 may be formed by injection molding.

The rotating device X may include the reduction gear module 600. The reduction gear module 600 may be configured to reduce a rotation speed of the rotor 210 and transmit the rotation speed to other configurations.

The reduction gear module 600 may be coupled to the rotor 210. At least a portion of the reduction gear module 600 may be rotated at a speed corresponding to the speed of the rotor 210.

The reduction gear module 600 may be coupled to the rotor 210 to allow at least a portion of the reduction gear module 600 to be rotated at an angular velocity less than that of the rotor 210.

The at least a portion of the reduction gear module 600 may be rotated at a speed less than a speed at which the rotor 210 is rotated. Accordingly, the pulsator 40 may be rotated at a speed less than a speed at which the rotor 210 is rotated.

A deceleration method of the reduction gear module 600 will be described later with reference to the drawings.

The reduction gear module 600 may be positioned between the rotor 210 and the coupler 500. Accordingly, a volume occupied by the reduction gear module 600, the rotor 210, and the coupler 500 may be reduced.

The reduction gear module 600 may be provided to be received in the mounting space 210S of the motor assembly 200.

The reduction gear module 600 may be located below the coupler 500.

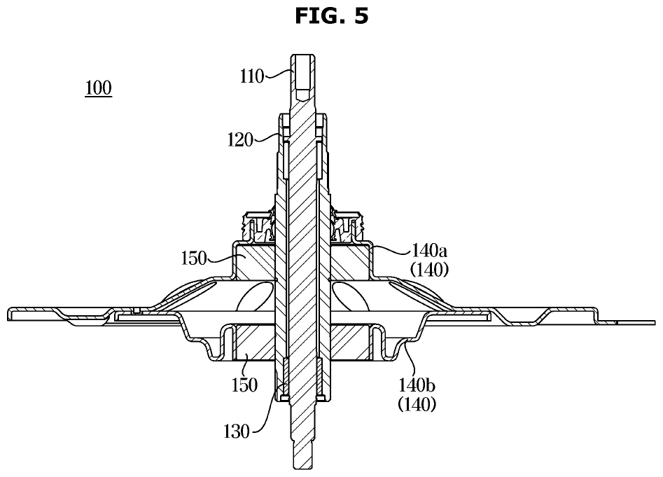

FIG. 5 is a cross-sectional view of the shaft assembly 100 of the washing machine 1 shown in FIG. 4.

A configuration of the shaft assembly 100 according to an embodiment of the disclosure will be described with reference to FIG. 5.

The washing machine 1 may include the shaft assembly 100.

The shaft assembly 100 may include a washing shaft 110. The washing shaft 110 may be configured to be coupled to the pulsator 40.

One side of the washing shaft 110 may be coupled to the pulsator 40. The other side opposite to the one side of the washing shaft 110 may be coupled to the reduction gear module 600.

Because the reduction gear module 600 is coupled to the rotor 210, the washing shaft 110 may transfer the rotational force of the rotor 210 to the pulsator 40. That is, when the rotor 210 is rotated, at least a portion of the reduction gear module 600 may be rotated, and when the at least a portion of the reduction gear module 600 is rotated, the washing shaft 110 may be rotated. Because the washing shaft 110 is coupled to the pulsator 40, the washing shaft 110 may rotate the pulsator 40 according to the rotation of the rotor 210.

The washing shaft 110 may be coupled to the pulsator 40 and the reduction gear module 600 to allow the pulsator 40 to be rotated at an angular velocity less than that of the rotor 210.

The washing shaft 110 may be positioned to correspond to a rotation axis of the rotor 210.

The washing shaft 110 may have a shape extending in a longitudinal direction. The pulsator 40 and the reduction gear module 600 may be coupled to both ends of the washing shaft 110 in the longitudinal direction, respectively.

The washing shaft 110 may include a metal material for rigidity. However, it is not limited thereto.

The washing shaft 110 may be formed by a drawing process. However, it is not limited thereto.

The washing shaft 110 may include a washing toothed member 111 at a position to which the reduction gear module 600 is coupled. The washing toothed member 111 may be engaged with the reduction gear module 600.

The washing toothed member 111 may be located on the lower side of the washing shaft 110.

The shaft assembly 100 may include a spin-drying shaft 120. The spin-drying shaft 120 may be configured to be coupled to the drum 30.

The spin-drying shaft 120 may be coupled to the drum 30. One side of the spin-drying shaft 120 may be coupled to the drum 30. The other side of the spin-drying shaft 120 opposite to the one side may be connected to the coupler 500. The coupler 500 may be connectable to the rotor 210.

When the coupler 500 is connected to the rotor 210, the spin-drying shaft 120 may transmit the rotational force of the rotor 210 to the drum 30. That is, when the rotor 210 is rotated, the coupler 500 may be rotated, and when the coupler 500 is rotated, the spin-drying shaft 120 may be rotated. Because the spin-drying shaft 120 is coupled to the drum 30, the spin-drying shaft 120 may rotate the drum 30 according to the rotation of the rotor 210.

The spin-drying shaft 120 may be positioned to correspond to the rotation axis of the rotor 210.

The spin-drying shaft 120 may have a tubular shape including a hollow. The washing shaft 110 may be received in the hollow of the spin-drying shaft 120. Accordingly, the rotation axis of the washing shaft 110 and the spin-drying shaft 120 may be shared.

The spin-drying shaft 120 may have a shape extending in the longitudinal direction. The drum 30 and the coupler 500 may be coupled to both ends of the spin-drying shaft 120 in the longitudinal direction, respectively.

The spin-drying shaft 120 may have a shorter length than the length of the washing shaft 110. Accordingly, the washing shaft 110 may protrude beyond the spin-drying shaft 120. A longitudinal end of the washing shaft 110 may protrude to be coupled to the pulsator 40 and the reduction gear module 600. The spin-drying shaft 120 may be provided outside the washing shaft 110. Accordingly, the spin-drying shaft 120 may be coupled to the drum 30 and the coupler 500 on the outside thereof.

The spin-drying shaft 120 may include a spin-drying toothed member 121. The spin-drying toothed member 121 may be configured to be engaged with the coupler 500.

The spin-drying toothed member 121 may be located on a lower side of the spin-drying shaft 120.

The spin-drying toothed member 121 may be located closer to the drum 30 than a ring toothed member 631.

The shaft assembly 100 may include a shaft bearing 130. The shaft bearing 130 may be configured to reduce friction between the washing shaft 110 and the spin-drying shaft 120.

The shaft bearing 130 may be positioned between the washing shaft 110 and the spin-drying shaft 120.

The shaft bearing 130 may have a ring shape.

The washing shaft 110 may be located inside the shaft bearing 130, and the spin-drying shaft 120 may be located outside the shaft bearing 130.

The shaft bearing 130 may be an oilless bearing. Because it is difficult for lubricating oil to enter between the shafts, an oilless bearing may be used to reduce the friction.

The shaft bearing 130 may be provided in plurality. The plurality of shaft bearings 130 may be provided on the upper and lower sides, respectively. Accordingly, the shaft bearing 130 may stably support the washing shaft 110 and the spin-drying shaft 120.

The shaft assembly 100 may include a cover bracket 140. The cover bracket 140 may cover the opening of the rotor 210.

The cover bracket 140 may be provided to extend radially from the spin-drying shaft 120 or the washing shaft 110.

The cover bracket 140 may cover the opening of the rotor 210 to prevent foreign substances from entering the inside of the rotating device X.

The cover bracket 140 may have irregularities on a surface thereof for rigidity.

The cover bracket 140 may include a metal material. However, it is not limited thereto.

The cover bracket 140 may be formed by a press process. However, it is not limited thereto.

The cover bracket 140 may be provided in plurality. The plurality of cover brackets 140 may include a first cover bracket 140a exposed toward one side, and a second cover bracket 140b positioned on the opposite side of the first cover bracket 140a.

The shaft assembly 100 may include a cover bearing 150. The cover bearing 150 may be configured to allow the cover bracket 140 and the spin-drying shaft 120 to be rotated smoothly with each other.

The cover bearing 150 may be positioned between the cover bracket 140 and the spin-drying shaft 120.

The cover bearing 150 may have a ring shape.

The spin-drying shaft 120 may be positioned inside the cover bearing 150.

The cover bracket 140 may be positioned outside the cover bearing 150.

The cover bearing 150 may include a ball bearing.

The cover bearing 150 may be provided in plurality. The plurality of cover bearings 150 may include a cover bearing 150 located between the first cover bracket 140a and the spin-drying shaft 120, and a cover bearing 150 located between the second cover bracket 140b and the spin-drying shaft 120.

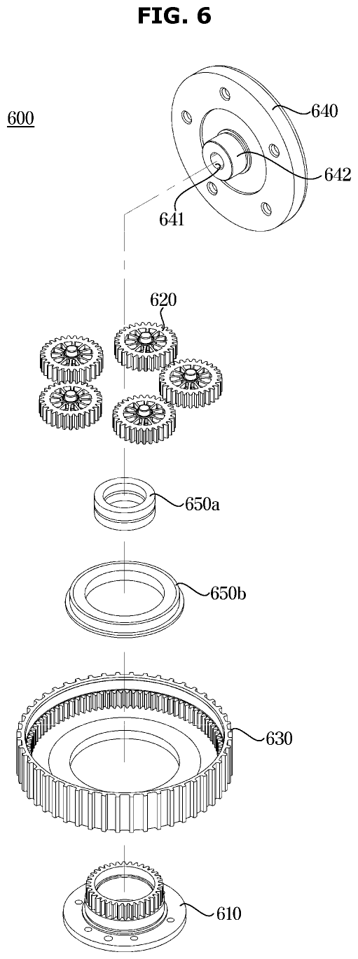

FIG. 6 is an exploded view of the reduction gear module 600 of the washing machine 1 shown in FIG. 4.

The reduction gear module 600 according to an embodiment of the disclosure will be described with reference to FIG. 6.

The washing machine 1 may include the reduction gear module 600.

The motor assembly 200 is an electronic component, and has a speed with optimum efficiency. In general, the motor assembly 200 may have optimum efficiency at about 100 rpm.

The pulsator 40 has optimum washing efficiency at about 50 rpm.

It is required for the motor assembly 200 to have the optimal efficiency while maintaining the washing efficiency of the pulsator 40. For this, the reduction gear module 600 may be provided.

The reduction gear module 600 may be coupled to the motor assembly 200. Accordingly, a portion of the reduction gear module 600 may be rotated at a rotation speed corresponding to a rotation speed of the motor assembly 200. That is, the portion of the reduction gear module 600 may be rotated at a rotation speed of about 100 rpm.

The reduction gear module 600 may be coupled to the washing shaft 110. Therefore, when a portion of the reduction gear module 600 is decelerated and rotated, the reduction gear module 600 may rotate the washing shaft 110, which is engaged with the portion, at a speed that is less than the rotation speed of the motor assembly 200. That is, the portion of the reduction gear module 600 may be rotated at a rotation speed of about 50 rpm.

A description thereof will be described in more detail.

The reduction gear module 600 may include a sun gear 610. The sun gear 610 may be a gear that receives the rotational force of the rotor 210.

The sun gear 610 may be coupled to the rotor 210. The sun gear 610 may be rotated at the same rotation speed as the rotation speed of the rotor 210.

A rotation axis of the sun gear 610 may be aligned with the rotation axis of the rotor 210.

The sun gear 610 may have a ring shape on a side coupled to the rotor 210. The ring-shaped part and the rotor 210 may be coupled by a fastening member. The ring shape may be located on the lower side of the sun gear 610.

The sun gear 610 may have a shape extending toward a carrier 640 from the ring shape. A toothed member may be positioned outside the extending shape.

The reduction gear module 600 may include a pinion gear 620. The pinion gear 620 may be a gear that surrounds the sun gear 610 and is engaged with the sun gear 610.

The pinion gear 620 may be a spur gear.

A toothed member may be located on an outside of the pinion gear 620. The pinion gear 620 may be engaged with the sun gear 610.

The pinion gear 620 may be rotated as the sun gear 610 is rotated.

The pinion gear 620 may be moved along an outer circumference of the sun gear 610 or the pinion gear 620 may be rotated while a position thereof is fixed.

The pinion gear 620 may be provided in plurality. The plurality of pinion gears 620 may be arranged at equal intervals around the sun gear 610. However, it is not limited thereto.

The reduction gear module 600 may include a ring gear 630. The ring gear 630 may be a gear surrounding the pinion gear 620.

A rotation axis of the ring gear 630 may be aligned with the rotation axis of the rotor 210.

The ring gear 630 may be engaged with the pinion gear 620. The ring gear 630 may include a toothed member that is positioned inside the ring gear 630 and engaged with the pinion gear 620.

The ring gear 630 may have a ring shape.

The ring gear 630 may include a toothed member that is positioned inside the ring gear 630 and engaged with the pinion gear 620.

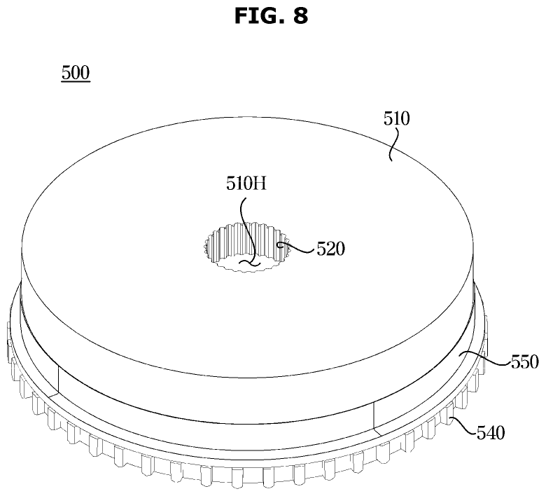

The ring gear 630 may include the ring toothed member 631 that is positioned outside the ring gear 630 and engaged with the coupler 500 (refer to FIG. 8).

The ring gear 630 may include a plastic material. However, it is not limited thereto.

The ring gear 630 may be formed by injection molding.

The reduction gear module 600 may include the carrier 640. The carrier 640 may be configured to be coupled to the washing shaft 110.

A rotation axis of the carrier 640 may be aligned with the rotation axis of the rotor 210.

The carrier 640 may be coupled to the pinion gear 620. The pinion gear 620 may be arranged in a circumferential direction around the rotation axis.

When a plurality of pinion gears 620 is provided, each of the plurality of pinion gears 620 may be coupled to the carrier 640 at a rotation axis of the plurality of pinion gears 620.

The carrier 640 may be rotated along with the pinion gear 620 when the pinion gear 620 is moved. As the carrier 640 is rotated, the carrier 640 may rotate the washing shaft 110.

The carrier 640 may include a carrier toothed member 641 engaged with the washing toothed member 111 of the washing shaft 110. The carrier toothed member 641 may be provided to extend in a vertical direction.

The carrier 640 may include a carrier toothed forming member 642 protruding toward the inside of the ring gear 630. Accordingly, the washing shaft 110 may be inserted into the carrier toothed forming member 642. As a contact area between the washing shaft 110 and the carrier toothed forming member 642 increases, frictional force may increase and thus separation may be prevented.

The carrier toothed member 641 may be provided on the carrier toothed forming member 642. The carrier toothed member 641 may be formed inside the carrier toothed forming member 642.

The reduction gear module 600 may include a gear bearing 650. The gear bearing 650 may be a component that reduces friction between the sun gear 610 and other components in contact with the sun gear 610.

The gear bearing 650 may be provided in plurality. The plurality of gear bearings 650 may include a first gear bearing 650a positioned between the sun gear 610 and the carrier 640. The plurality of gear bearings 650 may include a second gear bearing 650b positioned between the sun gear 610 and the ring gear 630.

In summary, the reduction gear module 600 may include the sun gear 610 coupled to the rotor 210 and rotatable by the rotor 210. The reduction gear module 600 may include the plurality of pinion gears 620 engaged with the sun gear 610 to be rotated around the sun gear 610. The reduction gear module 600 may include the ring gear 630 engaged with the outside of the plurality of pinion gears 620 so as to be relatively rotated with the plurality of pinion gears 620. The ring gear 630 may include the ring toothed member 631 engaged with a second toothed member 530. The reduction gear module 600 may include the carrier 640 coupled to each of the plurality of pinion gears 620 on the rotation axis of each of the plurality of pinion gears 620, and coupled to the washing shaft 110 to be rotated together.

Deceleration of the reduction gear module 600 will be described in detail below.

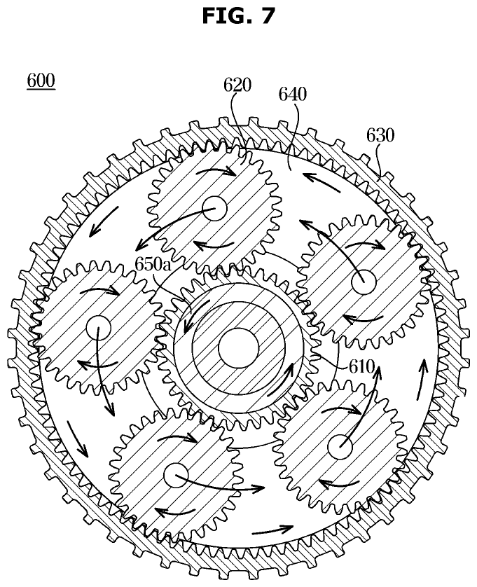

FIG. 7 is a cross-sectional view of the reduction gear module 600 of the washing machine 1 shown in FIG. 4.

An operation of the reduction gear module 600 according to an embodiment of the disclosure will be described with reference to FIG. 7. FIG. 7 illustrates the reduction gear module 600 taken along a direction in which the carrier 640 is visible.

As illustrated in FIG. 7, it will be described with an assumption that the sun gear 610 is rotated counterclockwise. In a case in which the sun gear 610 is rotated clockwise, it will be understood that the rotation direction is reversed in the following description.

The sun gear 610 may be rotated counterclockwise. Because the sun gear 610 is rotated by the rotor 210, the rotor 210 may be rotated counterclockwise. The sun gear 610 may be rotated counterclockwise by the rotation of the rotor 210.

The pinion gear 620 engaged with the sun gear 610 may be rotated by the rotation of the sun gear 610.

It is assumed that the ring gear 630 is in a fixed state. The ring gear 630 may be configured to be rotated, but it is assumed that the ring gear 630 is in a fixed state according to an embodiment.

Because the ring gear 630 is fixed, the pinion gear 620 may be moved between the ring gear 630 and the sun gear 610 according to the rotation of the sun gear 610.

Particularly, when the sun gear 610 is rotated counterclockwise, the pinion gear 620 engaged with the sun gear 610 may be rotated clockwise. The pinion gear 620 may be moved counterclockwise around the sun gear 610 while being rotated clockwise.

The carrier 640 connected to the pinion gear 620 may be rotated counterclockwise when the pinion gear 620 is moved counterclockwise.

When the carrier 640 is rotated counterclockwise, the washing shaft 110 connected to the carrier 640 may be rotated counterclockwise. The washing shaft 110 may be rotated by the carrier 640.

The reduction gear module 600 may be a kind of planetary gear.

In the above-mentioned description, the rotation speed of the ring gear 630 is greater than the rotation speed of the carrier 640. In other words, the rotation speed input to the ring gear 630 is reduced as being output from the carrier 640. That is, it is decelerated.

When a speed input to the ring gear 630 is output from the carrier 640, a rate of deceleration is as follows.

$$\frac{1}{\frac{the number of teeth of pinion gear}{the numberof teeth of sun gear}} + 1$$

The deceleration function of the reduction gear module 600 has been described above. However, in addition to the deceleration of the washing shaft 110, it is required for the washing shaft 110 to be rotated together with the spin-drying shaft 120 when the washing machine 1 performs the spin-drying operation. The reduction gear module 600 may also perform a function of guiding the rotation of the washing shaft 110. This will be described later with reference to the related drawings.

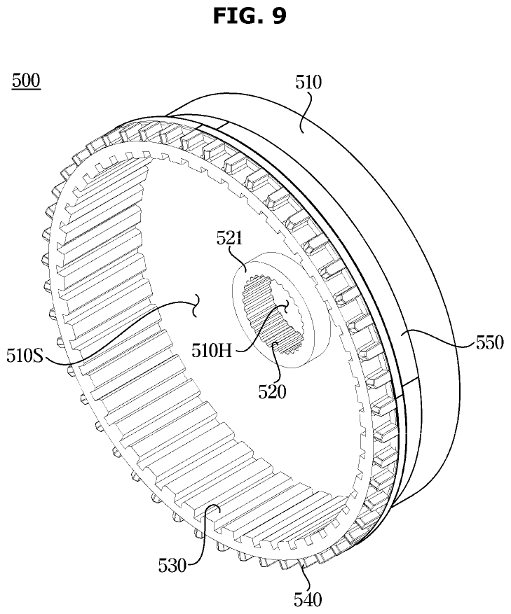

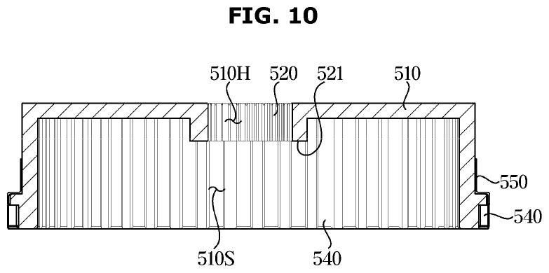

FIG. 8 is a perspective view of the coupler 500 of the washing machine 1 shown in FIG. 4. FIG. 9 is a perspective view of the coupler 500 of the washing machine 1 shown in FIG. 8 when viewed from another angle. FIG. 10 is a cross-sectional view of the coupler 500 of the washing machine 1 shown in FIG. 8.

The coupler 500 according to an embodiment of the disclosure will be described with reference to FIGS. 8 to 10.

The washing machine 1 may include the coupler 500.

A rotation axis of the coupler 500 may be aligned with the rotation axis of the rotor 210.

The coupler 500 may be a component configured to control the rotation of the washing shaft 110 and the spin-drying shaft 120 by being coupled or not being coupled to the spin-drying shaft 120 (refer to FIG. 4), the reduction gear module 600 (refer to FIG. 4) and the rotor 210.

The coupler 500 may be coupled to the spin-drying shaft 120 and the rotor 210 so as to rotate the spin-drying shaft 120 at the angular velocity of the rotor 210, and the coupler 500 may include a receiving space 510S formed therein to receive the reduction gear module 600.

The coupler 500 may be provided to be received in the mounting space 210S of the motor assembly 200.

The coupler 500 may include a coupler body 510 defining an appearance.

The coupler body 510 may have a substantially cylindrical shape with one side open.

The coupler body 510 may include an upper wall on the upper side thereof and an open lower wall on the lower side.

The receiving space 510S may be defined inside the coupler body 510. The receiving space 510S may be a space defined by the upper wall of the coupler body 510 located on the upper side and the side wall of the coupler body 510. The reduction gear module 600 may be received in the receiving space 510S. Accordingly, a volume occupied by the reduction gear module 600 and the coupler body 510 may be reduced.

The coupler body 510 may include a spin-drying shaft hole 510H on the upper wall. A center of the spin-drying shaft hole 510H may be positioned to allow the rotation axis of the coupler 500 to pass through.

The coupler main body 510 may include a toothed forming member 521 defining the spin-drying shaft hole 510H. The toothed forming member 521 may be provided to allow a first toothed member 520, which is to be described later, to be located on an inside thereof.

The toothed forming member 521 may have a ring shape. The spin-drying shaft hole 510H may be defined at the center of the ring shape of the toothed forming member 521.

The toothed forming member 521 may extend along the spin-drying shaft 120. The toothed forming member 521 may extend from the coupler body 510. The toothed forming member 521 may protrude downward from the coupler body 510. As a result, a contact area between the spin-drying shaft 120 and the first toothed member 520 is increased, and thus the spin-drying shaft 120 may be prevented from being separated from the coupler 500.

The coupler 500 may include the first toothed member 520. The first toothed member 520 may be a toothed member configured to be coupled to the spin-drying shaft 120.

The first toothed member 520 may be engaged with the spin-drying toothed member 121 provided on the spin-drying shaft 120. When the coupler 500 is rotated, the first toothed member 520 may be rotated. Accordingly, the spin-drying toothed member 121 engaged with the first toothed member 520 may be rotated. As the spin-drying toothed member 121 is rotated, the spin-drying shaft 120 may be rotated.

The first toothed member 520 may be located on the coupler body 510. The first toothed member 520 may be located on the upper side of the coupler body 510. The first toothed member 520 may be arranged along an edge of the spin-drying shaft hole 510H defined on the coupler body 510. The first toothed member 520 may be arranged along an outer surface of the spin-drying shaft hole 510H defined on the coupler body 510.

The first toothed member 520 may extend along the longitudinal direction of the spin-drying shaft 120. The first toothed member 520 may extend in the vertical direction.

The first toothed member 520 may extend from the coupler body 510 along the spin-drying shaft 120 to increase a contact area with the spin-drying shaft 120.

The coupler 500 may include the second toothed member 530. The second toothed member 530 may be a toothed member connected to the ring gear 630 (refer to FIG. 7).

The second toothed member 530 may be engaged with the ring toothed member 631. When the coupler 500 is rotated, the second toothed member 530 may be rotated. Accordingly, the ring toothed member 631 engaged with the second toothed member 530 may be rotated. As the ring toothed member 631 is rotated, the ring gear 630 may be rotated.

The second toothed member 530 may be in contact with the ring toothed member 631. The second toothed member 530 may be configured to allow the coupler 500 to be in contact with the ring gear 630. Because the coupler 500 is connected to the drum 30 through the spin-drying shaft 120, the inertia of the drum 30 may limit the movement of the ring gear 630. Accordingly, in order to prevent the movement of the ring gear 630, it is possible to transmit the inertia of the drum 30 to the ring gear 630.

That is, the coupler 500 may be coupled to the spin-drying shaft 120 coupled to the drum 30, and the ring gear 630 to limit the movement of the ring gear 630 while the washing machine 1 performs the washing operation.

The second toothed member 530 may be located inside the coupler body 510. The second toothed member 530 may be located on an outer surface of the receiving space 510S defined in the coupler 500. The second toothed member 530 may be located inside the sidewall of the coupler body 510. The second toothed member 530 may extend downward from the upper wall inside the coupler body 510.

The second toothed member 530 may be located inside the coupler body 510 to allow the ring gear 630 to be received in the receiving space 510S.

The coupler 500 may include a third toothed member 540. The third toothed member 540 may be connected to the rotor 210 (refer to FIG. 4).

The third toothed member 540 may be engaged with a rotor toothed member 211 (refer to FIG. 4) included in the rotor 210. When the rotor 210 is rotated, the rotor toothed member 211 may be rotated. When the rotor toothed member 211 is rotated, the third toothed member 540 engaged with the rotor toothed member 211 may be rotated. When the third toothed member 540 is rotated, the coupler 500 may be rotated. When the coupler 500 is rotated, the spin-drying shaft 120 may be rotated, and thus the drum 30 may be rotated.

The rotor toothed member 211 may be located farther from the drum 30 than the ring toothed member 631.

However, the third toothed member 540 may or may not be engaged with the rotor toothed member 211. The coupler 500 may or may not be rotated by the third toothed member 540. When the coupler 500 is rotated or is not rotated, the drum 30 may or may not be rotated.

The third toothed member 540 may be located on an outer surface of the coupler body 510. The third toothed member 540 may be located on the outer surface of the sidewall of the coupler body 510. The third toothed member 540 may be located on a lower side of the sidewall of the coupler body 510. The third toothed member 540 may be arranged to extend circumferentially along the coupler body 510.

The third toothed member 540 may be positioned outside the coupler body 510 so as to be engaged with the rotor 210 on the outside of the coupler body 510 while the washing machine 1 performs the spin-drying operation.

In summary, the coupler 500 may include the first toothed member 520 engaged with the spin-dry shaft 120 when the washing machine 1 is in the spin-drying operation, the second toothed member 530 engaged with the reduction gear module 600 when the washing machine 1 is in the spin-drying operation, and the third toothed member 540 engaged with the rotor 210 when the washing machine 1 is in the spin-drying operation.

As the coupler 500 is positioned in a first position while the washing machine 1 performs the washing operation, the first toothed member 520 may be coupled to the spin-drying toothed member 121, the second toothed member 530 may be coupled to the ring toothed member 631, and the third toothed member 540 may be disengaged from the rotor toothed member 211.

As the coupler 500 is positioned in a second position farther from the drum 30 than the first position while the washing machine 1 performs the spin-drying operation, the first toothed member 520 may be coupled to the spin-drying toothed member 121, the second toothed member 530 may be coupled to the ring toothed member 631, and the third toothed member 540 may be coupled to the rotor toothed member 211.

The coupler 500 may include a yoke 550. The yoke 550 may be configured to interact with the coupler lifting device 400.

The yoke 550 may include a metal material. The coupler lifting device 400 described below may include a solenoid 420 configured to generate a magnetic field, and thus the yoke 550 may include a material having a property capable of responding to a magnetic field.

The yoke 550 may be located outside the coupler body 510. This is because the coupler lifting device 400 is positioned to surround the coupler body 510 so as to allow the yoke 550 to have a position corresponding thereto.

The yoke 550 may be located on the lower side of the coupler body 510. The yoke 550 may be positioned on the upper side of the third toothed member 540 positioned on the lower side of the coupler body 510.

The yoke 550 may be supported by the third toothed member 540. The third toothed member 540 may be in contact with the lower side of the yoke 550.

The yoke 550 may have a ring shape. The coupler body 510 may be received inside the yoke 550.

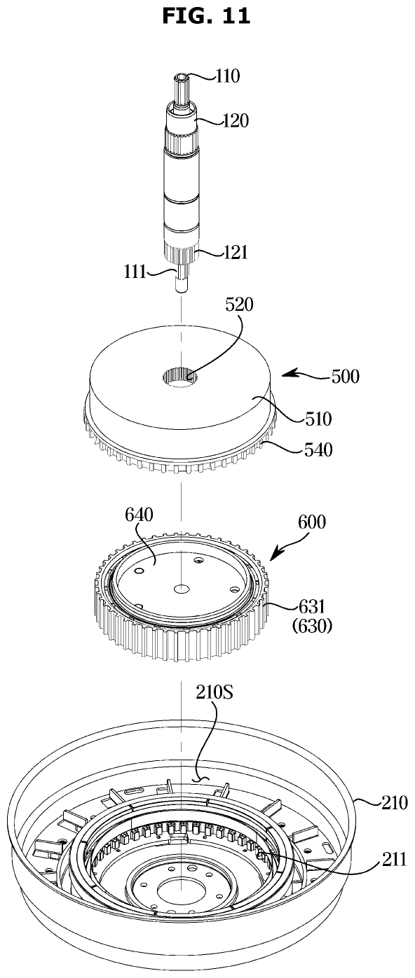

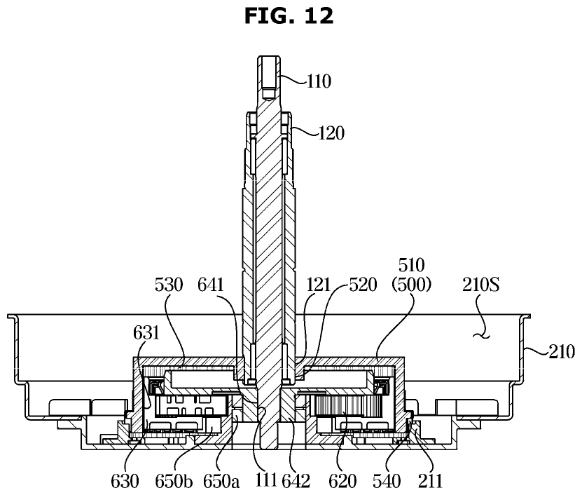

FIG. 11 is an exploded view of a configuration related to the washing operation or the spin-drying operation among configurations of the washing machine 1 shown in FIG. 4. FIG. 12 is a cross-sectional view illustrating a state in which configurations of washing machine 1 shown in FIG. 11 are coupled.

Power transmission of the rotating device X according to an embodiment of the disclosure will be described with reference to FIGS. 11 and 12.

The rotating device X may include the washing shaft 110 and the spin-drying shaft 120.

As mentioned above, the washing shaft 110 may be coupled to the pulsator 40. The spin-drying shaft 120 may be coupled to the drum 30.

The motor assembly 200 may generate a rotational force, and the rotational force generated by the motor assembly 200 may be transmitted to the pulsator 40 and the drum 30 through the washing shaft 110 and the spin-drying shaft 120, respectively.

Hereinafter a process in which the motor assembly 200 transmits power will be described.

First, the coupling of components for transmitting power of the rotating device X will be described.

The motor assembly 200 may include the fixed stator 220 and the rotating rotor 210.

The rotor 210 may be coupled to the sun gear 610 of the reduction gear module 600. The sun gear 610 may be rotated together with the reduction gear module 600 as the reduction gear module 600 is rotated.

The sun gear 610 may engaged with the pinion gear 620. Therefore, the pinion gear 620 may be rotatable by the rotation of the sun gear 610.

The pinion gear 620 may be coupled to the carrier 640. As the pinion gear 620 is moved, the carrier 640 may be rotated.

The washing shaft 110 may be coupled to the carrier 640. The washing shaft 110 may be rotated together with the carrier 640 as the carrier 640 is rotated.

The rotor 210 may include the rotor toothed member 211. The rotor toothed member 211 may be a toothed member engaged with the reduction gear module 600.

The rotor toothed member 211 may be positioned on the lower side of the rotor 210.

The third toothed member 540 of the coupler 500 may be engaged with the rotor toothed member 211. As the rotor 210 is rotated, the coupler 500 may be rotated.

The coupler 500 may be engaged with the spin-drying shaft 120. According to the rotation of the coupler 500, the spin-drying shaft 120 may be rotated. The first toothed member 520 of the coupler 500 may be engaged with the washing toothed member 111 of the washing shaft 110.

The coupler 500 may be engaged with the ring gear 630. The coupler 500 may or may not be rotated with the ring gear 630. The second toothed member 530 of the coupler 500 may engaged with the ring toothed member 631 of the ring gear 630.

Hereinafter a power transmission process of the rotating device X will be described.

For convenience of description, it is assumed that the third toothed member 540 of the coupler 500 is engaged with the rotor toothed member 211.

The rotor 210 may be rotated by the current flowing through the stator 220. The rotor 210 may be rotated about the rotation axis of the rotor 210.

When the rotor 210 is rotated, the sun gear 610 may be also rotated. When the sun gear 610 is rotated, the pinion gear 620 may be also rotated. The pinion gear 620 may be rotated and moved. When the pinion gear 620 is moved, the carrier 640 may be rotated about the rotation axis of the sun gear 610. When the carrier 640 is rotated, the washing shaft 110 may be rotated. When the washing shaft 110 is rotated, the pulsator 40 may be rotated.

When the rotor 210 is rotated, the coupler 500 may be rotated together. When the coupler 500 is rotated, the spin-drying shaft 120 connected to the coupler 500 may be rotated together. When the spin-drying shaft 120 is rotated, the drum 30 may also be rotated.

In summary, the rotational force of the rotor 210 may be transmitted to the washing shaft 110 by the reduction gear module 600. The rotational force of the rotor 210 may be transmitted to the spin-drying shaft 120 by the coupler 500.

The rotating device X may include the gear bearing 650. The gear bearing 650 may be configured to allow the sun gear 610 and peripheral components to be rotated independently of each other.

The gear bearing 650 may include a first gear bearing 650a and a second gear bearing 650b.

The first gear bearing 650a may support the sun gear 610 and the ring gear 630 to allow the sun gear 610 and the ring gear 630 to be rotated independently of each other.

The second gear bearing 650b may support the sun gear 610 and the carrier 640 to allow the sun gear 610 and the carrier 640 to be rotated independently of each other.

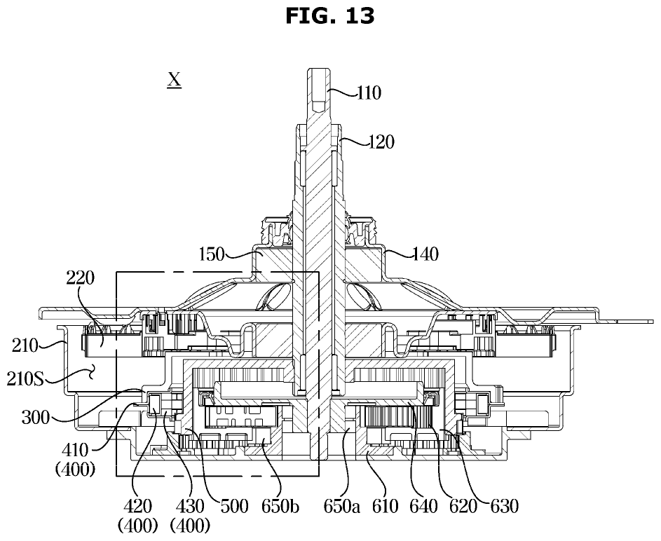

FIG. 13 is a cross-sectional view illustrating the rotating device X of the washing machine 1 shown in FIG. 3.

A component that has not been described in the rotating device X according to an embodiment of the disclosure will be described with reference to FIG. 13.

The rotating device X may include the coupler lifting device 400. The coupler lifting device 400 may be configured to move the coupler 500.

The coupler lifting device 400 may be positioned adjacent to the coupler 500. The coupler lifting device 400 may be positioned to surround the coupler 500.

The coupler lifting device 400 may be positioned at a height corresponding to the coupler 500.

The coupler lifting device 400 may be positioned at a height corresponding to the yoke 550 of the coupler 500.

The coupler lifting device 400 may be coupled to the support bracket 300.

The coupler lifting device 400 may have a ring shape. The coupler 500 may be received inside the coupler lifting device 400.

The coupler lifting device 400 may include a lifting housing 410. The lifting housing 410 may be a component defining an appearance of the coupler lifting device 400.

The lifting housing 410 may have a ring shape.

The lifting housing 410 may define a space capable of receiving other components therein.

The lifting housing 410 may be coupled to the support housing.

The coupler lifting device 400 may include the solenoid 420. The solenoid 420 may be configured to generate a magnetic field as a current flow.

The solenoid 420 may be configured to emit a magnetic field.

A current may flow through the solenoid 420. As the current flows, a magnetic field may be generated. The coupler 500 may be moved in response to the magnetic field generated by the solenoid 420. The yoke 550 of the coupler 500 may respond to the magnetic field.

The yoke 550 may be configured to interact with the magnetic field emitted by the solenoid 420.

The coupler 500 may be moved between the first position and the second position according to the magnetic field emitted by the solenoid 420.

The coupler 500 may be moved to the first position by the magnetic field generated by the solenoid 420. The first position may be a position in which the washing machine 1 is located while performing the washing operation. The first position may be a position in which the third toothed member 540 of the coupler 500 is not engaged with the rotor toothed member 211 of the rotor 210.

The first position may be provided above the second position to be described later. The solenoid 420 may generate a magnetic field to attract the coupler 500. The solenoid 420 may move the coupler 500 upward.

The coupler 500 may be moved to the second position by the magnetic field generated by the solenoid 420. The second position may be a position in which the washing machine 1 is located while performing the spin-drying operation. The second position may be a position in which the third toothed member 540 of the coupler 500 is engaged with the rotor toothed member 211 of the rotor 210.

The second position may be provided below the first position. The solenoid 420 may generate a magnetic field to push the coupler 500. The solenoid 420 may move the coupler 500 downward.

Alternatively, the solenoid 420 may not generate a magnetic field to allow the coupler 500 to receive gravity and to be directed to the second position.

The solenoid 420 may be provided radially outside the coupler lifting device 400. The solenoid 420 may extend along a circumferential direction of the coupler lifting device 400.

The solenoid 420 may be located inside the lifting housing 410.

In summary, the coupler 500 may be moved between the first position, in which the third toothed member 540 is spaced apart from the rotor 210 to limit the rotation of the spin-drying shaft 120 while the washing machine 1 performs the washing operation, and the second position, in which the third toothed member 540 is engaged with the rotor 210 to rotate the spin-drying shaft 120 while the washing machine 1 performs the spin-drying operation.

The coupler lifting device 400 may include a permanent magnet 430. The permanent magnet 430 may refer to a magnet having a magnetic field that does not disappear over time.

The permanent magnet 430 may be configured to limit the movement of the coupler 500 when the coupler 500 is in the first position or the second position.

For example, when the coupler 500 is in the first position, the coupler 500 may receive gravity in the direction of gravity. In this case, the solenoid 420 may continuously generate a magnetic field in order to maintain the position of the coupler 500 at the first position. When the solenoid 420 continues to generate a magnetic field, power may continue to be consumed. However, when the coupler 500 is fixed to the first position through the permanent magnet 430 although the solenoid 420 does not generate a magnetic field, the position of the coupler 500 may be fixed without additional power consumption.

This may be applied as it is even when the coupler 500 is in the second position as well as when the coupler 500 is in the first position. Even when the coupler 500 is in the second position, the coupler 500 may be moved to another position by an external impact. Particularly, when the coupler 500 is in the second position, the washing machine 1 may perform the spin-drying operation. When the washing machine 1 performs the spin-drying operation, the drum 30 and the pulsator 40 may be rotated at high speed. Accordingly, an unwanted component may be rotated due to the movement of the coupler 500, and an accident may occur due to the rotation. The permanent magnet 430 may prevent the accident by fixing the position of the coupler 500.

The permanent magnet 430 may be positioned adjacent to the solenoid. The permanent magnet 430 may limit the movement of the coupler 500 when the coupler 500 is in the second position.

The permanent magnet 430 may be provided in plurality. The plurality of permanent magnets 430 may include a permanent magnet 430 located at a position corresponding to the first position of the coupler 500 so as to prevent the movement of the coupler 500 in the first position, and a permanent magnet 430 located at a position corresponding to the second position of the coupler 500 so as to prevent the movement of the coupler 500 in the second position.

The permanent magnet 430 may be positioned adjacent to the solenoid 420. The permanent magnet 430 may be located radially inner than the solenoid 420. The permanent magnet 430 may be provided to extend in a circumferential direction.

The permanent magnet 430 may be located inside the lifting housing 410.

When the coupler lifting device 400 includes the permanent magnet 430, it is required for the solenoid 420 to move the coupler 500 with a force that is greater than the attractive force of the permanent magnet 430 that pulls the coupler 500.

For example, in the case of moving the coupler 500 from the second position to the first position, the permanent magnet 430 may apply a force to the coupler 500 to allow the coupler 500 to be located in the second position. In this case, the solenoid 420 may move the coupler 500 toward the first position with a force greater than a force that is applied by the permanent magnet 430 to the coupler 500 to be located in the second position

In the case of moving the coupler 500 from the first position to the second position, the above-mentioned process is reversed.

The above-mentioned configuration of the rotating device X will be briefly described, and the positional relationship of the coupler 500 will be described in more detail.

The rotating device X may include the spin-drying shaft 120 connected to the drum 30, and the washing shaft 110 located inside the spin-drying shaft 120 and connected to the pulsator 40.

The spin-drying shaft 120 and the washing shaft 110 may be positioned to penetrate the cover bracket 140.

The cover bracket 140 may be positioned to cover the rotor 210.

The mounting space 210S may be defined inside the rotor 210. The rotor 210 may be provided to surround the mounting space 210S. The mounting space 210S may be located under the cover bracket 140.

The mounting space 210S may be formed inside the motor assembly 200.

The stator 220 may be located in the mounting space 210S. The stator 220 may be positioned below the cover bracket 140.

The support bracket 300 may be positioned below the stator 220.

The coupler lifting device 400 may be positioned under the outside of the support bracket 300.

The coupler 500 may be positioned under the inside of the support bracket 300.

The reduction gear module 600 may be positioned in the receiving space 510S of the coupler 500.

The rotor 210 may be positioned below the reduction gear module 600. The reduction gear module 600 may be positioned between the coupler 500 and the rotor 210.

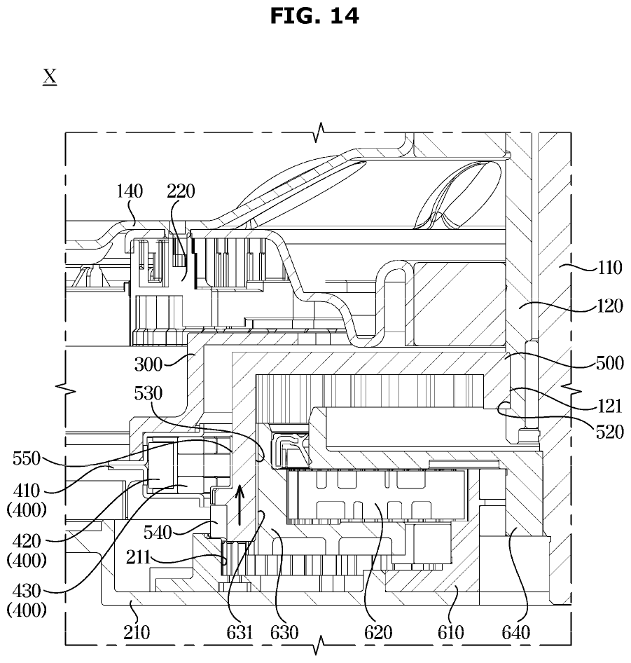

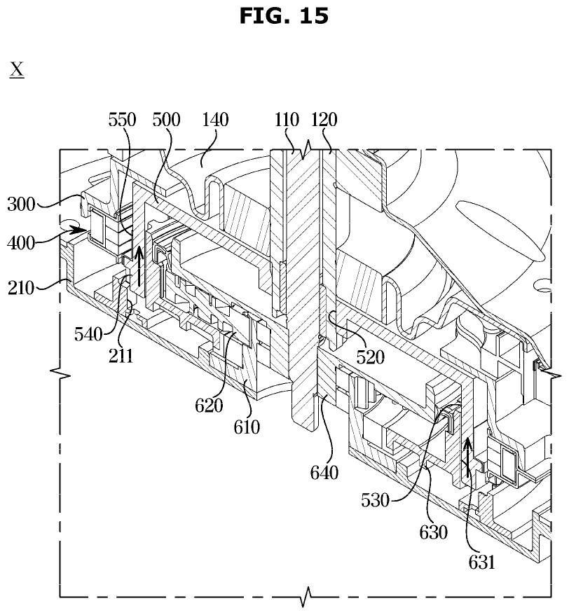

FIG. 14 is an enlarged cross-sectional view of a portion of the rotating device X when the washing machine 1 shown in FIG. 13 is in the washing operation. FIG. 15 is a cross-sectional perspective view of the rotating device X of the washing machine 1 shown in FIG. 14.

A case in which the coupler 500 according to an embodiment according to the disclosure is in the first position will be described with reference to FIGS. 14 and 15.

The coupler 500 may be located in the first position when the washing machine 1 performs the washing operation. The coupler 500 may be moved to the first position by the coupler lifting device 400.

When the coupler 500 is in the first position, the rotor toothed member 211 of the rotor 210 may be spaced apart from the third toothed member 540 of the coupler 500.

When the coupler 500 is in the first position, the coupler 500 may not be connected to the rotor 210. Because the coupler 500 is not connected to the rotor 210, the rotation of the coupler 500 may be prevented. Therefore, the rotation of the spin-drying shaft 120 connected to the coupler 500 may also be prevented. As the rotation of the spin-drying shaft 120 is prevented, the rotation of the drum 30 may also be prevented.

When the coupler 500 is in the first position, the coupler 500 may be connected to the ring gear 630. The coupler 500 may be connected to the spin-drying shaft 120, and thus the coupler 500 may be indirectly connected to the drum 30. Accordingly, the inertia of the drum 30 may be transmitted to the ring gear 630. The movement of the ring gear 630 may be limited by the inertia of the drum 30.

When the coupler 500 is in the first position, the rotor 210 may be rotated. As the rotor 210 is rotated, the sun gear 610 may be rotated. As the sun gear 610 is rotated, the pinion gear 620 may be rotated and moved. Particularly, the movement of the ring gear 630 may be prevented, and thus the pinion gear 620 may be rotated and moved simultaneously. When the pinion gear 620 is moved, the carrier 640 may be rotated. When the carrier 640 is rotated, the washing shaft 110 may be rotated.

In this case, the rotation speed of the rotor 210 may be reduced through reduction gear module 600, and then the reduced rotation speed may be transmitted to the washing shaft 110. Accordingly, the rotor 210 may have an optimal rotation speed and the washing shaft 110 may have a rotation speed suitable for washing.

In addition, in the washing operation of the washing machine 1, it is required to generate the water flow by rotating water inside the drum 30, and thus only the pulsator 40 needs to be rotated. As the coupler 500 is spaced apart from the rotor 210, the rotational force of the rotor 210 may not be transmitted to the spin-drying shaft 120, and thus the rotation of the drum 30 may be prevented.

Particularly, refer to the following description regarding the direction of rotation.

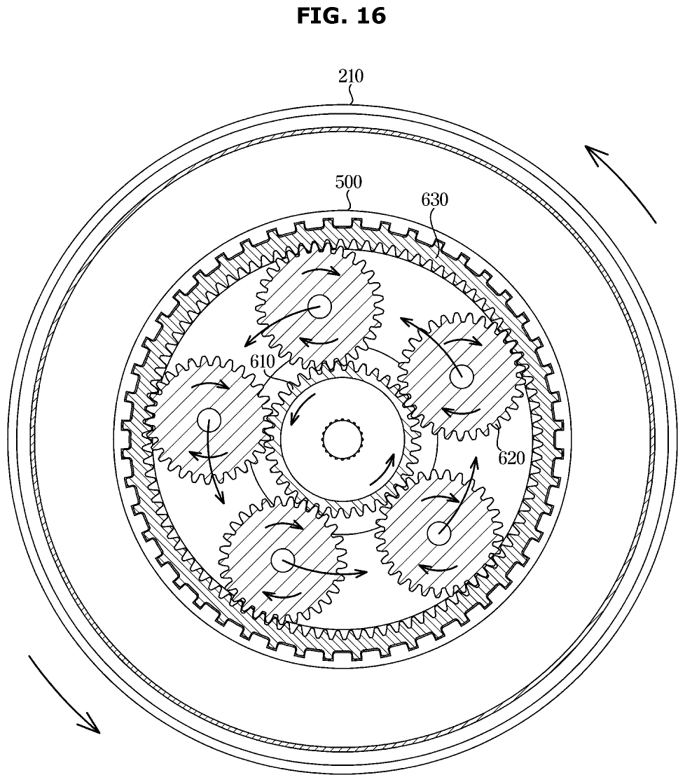

FIG. 16 is a cross-sectional view of the rotating device X of the washing machine 1 shown in FIG. 14.

The rotation of the rotating device X when the washing machine 1 according to an embodiment of the disclosure is in the washing operation will be described with reference to FIG. 16.

As illustrated in FIG. 16, it will be described with an assumption that the rotor 210 and the sun gear 610 are rotated counterclockwise. In a case in which the rotor 210 and the sun gear 610 are rotated clockwise, it will be understood that the rotation direction is reversed in the following description.

The rotor 210 and the sun gear 610 may be rotated counterclockwise.

When the sun gear 610 is rotated counterclockwise, the pinion gear 620 may be rotated clockwise.

The pinion gear 620 may be moved counterclockwise while being rotated clockwise.

As the pinion gear 620 is moved counterclockwise, the carrier 640 and the washing shaft 110 may be rotated counterclockwise.

At this time, the rotation of the coupler 500 may be prevented.

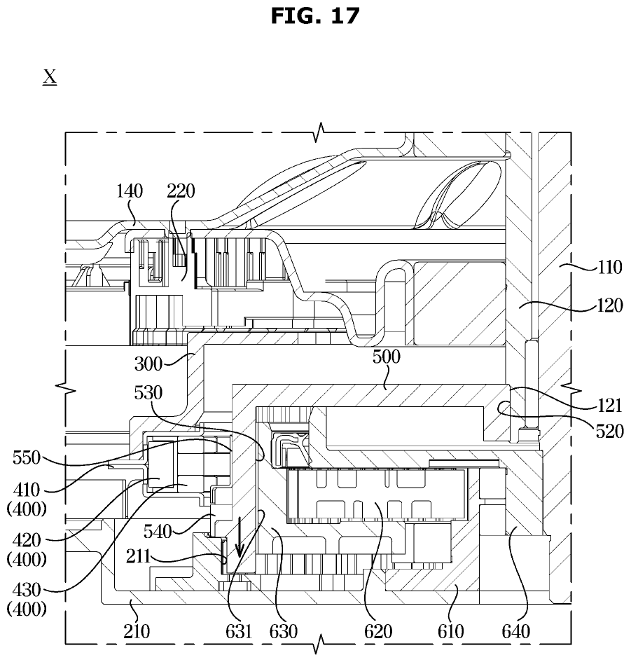

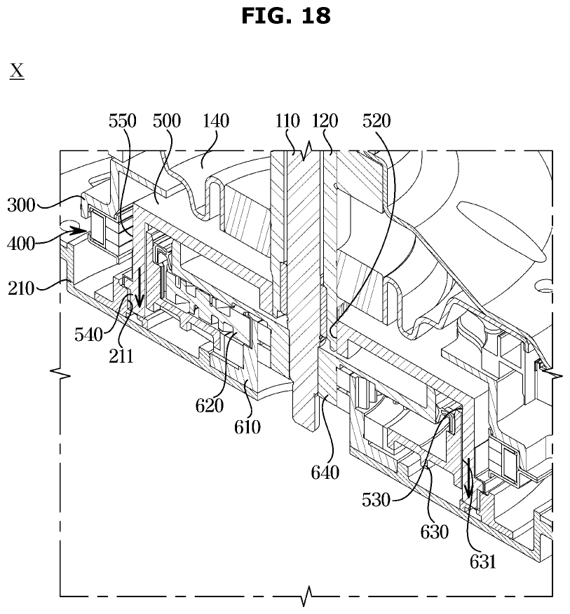

FIG. 17 is an enlarged cross-sectional view of a portion of the rotating device X when the washing machine 1 shown in FIG. 13 is in the spin-drying operation. FIG. 18 is a cross-sectional perspective view of the rotating device X of the washing machine 1 shown in FIG. 17.

A case in which the coupler 500 according to an embodiment according to the disclosure is in the second position will be described with reference to FIGS. 17 and 18.

The coupler 500 may be located at the second position when the washing machine 1 performs the spin-drying operation. The coupler 500 may be moved to the second position by the coupler lifting device 400.

When the coupler 500 is in the second position, the rotor toothed member 211 of the rotor 210 may be engaged with the third toothed member 540 of the coupler 500.

When the coupler 500 is in the second position, the coupler 500 may be connected to the rotor 210. Because the coupler 500 is connected to the rotor 210, the coupler 500 may be rotated. Accordingly, the spin-drying shaft 120 connected to the coupler 500 may also be rotated. As the spin-drying shaft 120 is rotated, the drum 30 may also be rotated.

When the coupler 500 is in the second position, the coupler 500 may be connected to the ring gear 630. The coupler 500 may be connected to the rotor 210, and thus when the rotor 210 is rotated, the ring gear 630 may be rotated together with the coupler 500.

When the coupler 500 is in the second position, the rotor 210 may be rotated. As the rotor 210 is rotated, the sun gear 610 may be rotated. As the sun gear 610 is rotated, the pinion gear 620 may be moved while the rotation of the pinion gear 620 is prevented. When the pinion gear 620 is moved, the carrier 640 may be rotated. When the carrier 640 is rotated, the washing shaft 110 may be rotated.

Particularly, the ring gear 630 may be rotated at the same angular velocity as the coupler 500. The coupler 500 may be rotated at the same speed as the rotational angular velocity of the rotor 210. This is because the rotor toothed member 211 of the rotor 210 is engaged with the third toothed member 540 of the coupler 500. As the rotor 210 is rotated, the coupler 500 may be rotated, and as the coupler 500 is rotated, the ring gear 630 may be rotated. The ring gear 630 may be rotated at the same angular velocity as the rotor 210.

Because the sun gear 610 is coupled to the rotor 210, the sun gear 610 may be rotated at the same angular velocity as the rotor 210. That is, the rotor 210 may be rotated at the same angular velocity as the sun gear 610 and the ring gear 630.

The pinion gear 620 interposed between the sun gear 610 and the ring gear 630 may be rotated at the same angular velocity as the sun gear 610 and the ring gear 630. Accordingly, the pinion gear 620 may be rotated at the same angular velocity as the sun gear 610 and the ring gear 630 in the circumferential direction around the rotation axis of the sun gear 610.

The carrier 640 connected to the pinion gear 620 may be rotated at the same angular velocity as the moving speed of the pinion gear 620. The washing shaft 110 connected to the carrier 640 may be rotated at the same angular velocity as the rotor 210. The pulsator 40 connected to the washing shaft 110 may be rotated at the same angular velocity as the rotor 210.

Because the rotor 210 and the coupler 500 are connected, the coupler 500 may be rotated at the same angular velocity as the rotor 210. The coupler 500 may be rotated at the same angular velocity as the spin-drying shaft 120. Because the drum 30 is connected to the spin-drying shaft 120, the drum 30 may be rotated at the same angular velocity as the spin-drying shaft 120. That is, the drum 30 may be rotated at the same angular velocity as the rotor 210.

In summary, when the washing machine 1 performs the spin-drying operation, the rotor 210, the pulsator 40, and the drum 30 may be rotated at the same angular velocity.

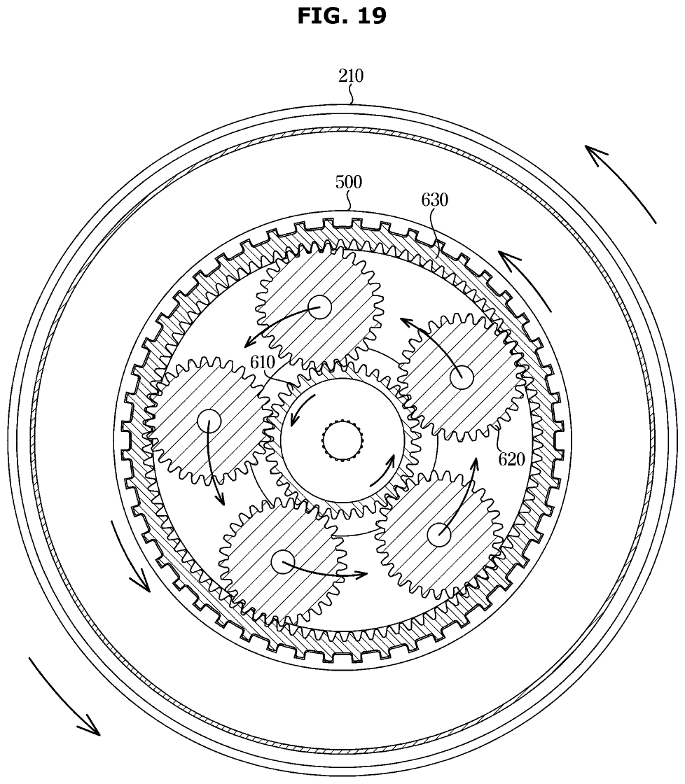

FIG. 19 is a cross-sectional view of the rotating device X of the washing machine 1 shown in FIG. 13.

The rotation of the rotating device X when the washing machine 1 according to an embodiment of the disclosure is in the spin-drying operation will be described with reference to FIG. 19.

As illustrated in FIG. 19, it will be described with an assumption that the rotor 210 and the sun gear 610 are rotated counterclockwise. In a case in which the rotor 210 and the sun gear 610 are rotated clockwise, it will be understood that the rotation direction is reversed in the following description.

The rotor 210 and the sun gear 610 may be rotated counterclockwise.

The coupler 500 connected to the rotor 210 may be rotated counterclockwise.

The ring gear 630 connected to the coupler 500 may be rotated counterclockwise.

When the sun gear 610 is rotated counterclockwise, the pinion gear 620 may be rotated counterclockwise. This is because the sun gear 610 and the ring gear 630 have the same angular velocity, but a speed at a contact point between the ring gear 630 and the pinion gear 620 is greater than a speed at a contact point between the sun gear 610 and the pinion gear 620.

The pinion gear 620 may be rotated around the rotation axis of the sun gear 610 together with the sun gear 610 and the ring gear 630. The moving angular velocity of the pinion gear 620 is equal to the angular velocity of the ring gear 630 and the sun gear 610. The pinion gear 620 may be moved counterclockwise around the rotation axis of the sun gear 610.

The carrier 640 and the washing shaft 110 connected to the pinion gear 620 may also be rotated counterclockwise. The pulsator 40 connected to the washing shaft 110 may be rotated counterclockwise.

The spin-drying shaft 120 connected to the coupler 500 may be rotated counterclockwise. The drum 30 connected to the spin-drying shaft 120 may be rotated counterclockwise.

That is, the drum 30 and the pulsator 40 may be rotated in the same direction.

In other words, while the washing machine 1 performs the spin-drying operation, the coupler 500 may be rotated at the same speed as the rotor 210 as the rotor 210 is rotated, and the ring gear 630 may be rotated together with the coupler 500 as the coupler 500 is rotated, and the spin-drying shaft 120 and the washing shaft 110 may be rotated at the same speed as the ring gear 630 and the carrier 640 as the ring gear 630 and the carrier 640 are rotated.

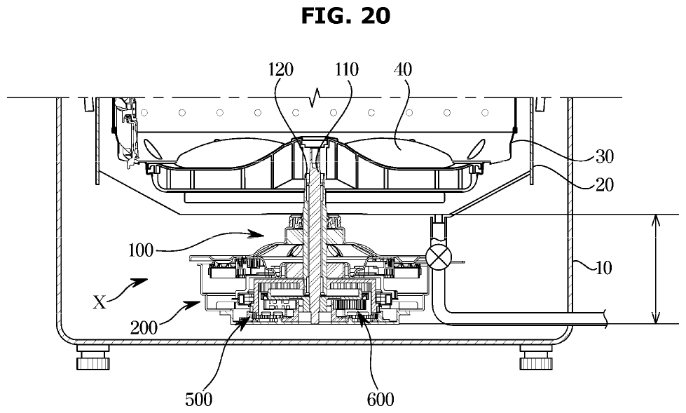

FIG. 20 is a cross-sectional view illustrating the rotating device of the washing machine shown in FIG. 2 and a peripheral configuration thereof.

A height of the rotating device X according to an embodiment of the disclosure will be described with reference to FIG. 20.

The washing machine 1 may include the rotating device X.

The rotating device X may include the rotor 210 including the mounting space 210S.

The stator 220, the support bracket 300, the coupler lifting device 400, the coupler 500, and the reduction gear module 600 may be received in the mounting space 210S.

A height of the rotating device X when the stator 220, the support bracket 300, the coupler lifting device 400, the coupler 500, and the reduction gear module 600 are received in the mounting space 210S, may be reduced in comparison with when the stator 220, the support bracket 300, the coupler lifting device 400, the coupler 500, and the reduction gear module 600 are located outside the rotor 210.

Additionally, the coupler 500 may include the receiving space 510S.

The reduction gear module 600 may be received in the receiving space 510S.

The height of the rotating device X when the reduction gear module 600 is received in the receiving space 510S may be reduced in comparison with when the reduction gear module 600 is located outside the coupler 500.

When a height of the conventional washing machine 1 is maintained in a state in which the height of the rotating device X is reduced, a height of the drum 30 may be increased and the washing capacity may be increased.

When the height of the washing machine 1, in which the height of the rotating device X is reduced, is reduced in comparison with the height of the conventional washing machine 1, a user can easily put clothes into the drum 30.

That is, the reduction of the height of the rotating device X may obtain various advantages.

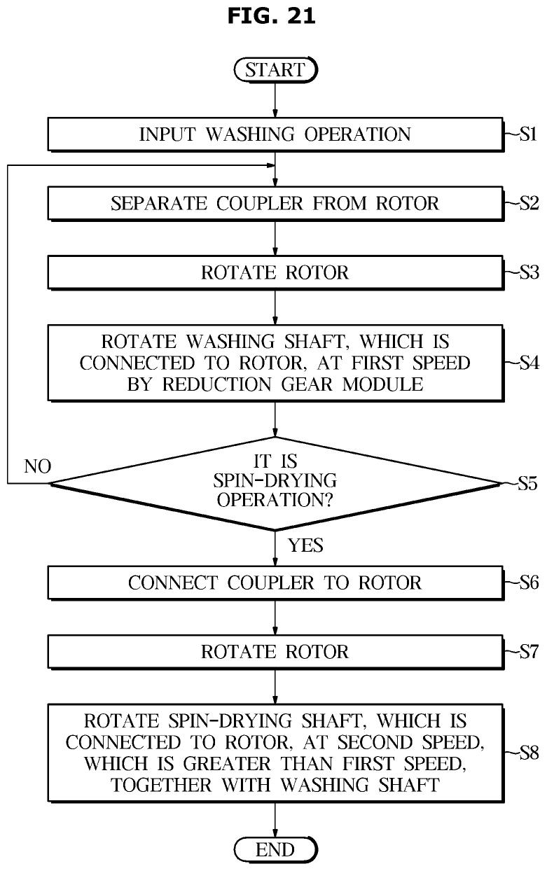

FIG. 21 is a flow chart illustrating a state in which the coupler 500 of the washing machine 1 shown in FIG. 4 is controlled in the washing operation or the spin-drying operation.

A control of the washing machine 1 in the washing operation or the spin-drying operation will be described with reference to FIG. 21.

In response to the washing machine 1 performing the washing operation, the coupler 500 may be moved to separate the coupler 500 and the rotor 210 (1).

The rotor 210 may be rotated (2).

The washing shaft 110 connected to the rotor 210 may be rotated at a first rotation speed through the reduction gear module 600 (3).

In response to the washing machine 1 performing the spin-drying operation, the coupler 500 may be moved to allow the coupler 500 and the rotor 210 to be connected (4).

The rotor 210 may be rotated (6).

The spin-drying shaft 120 connected to the rotor 210 may be rotated together with the washing shaft 110 at a second rotation speed greater than the first rotation speed (7).

In the above-mentioned description, an embodiment of the disclosure has been described. Hereinafter other embodiments of the disclosure will be described. In describing other embodiments, the same reference numerals may be assigned to the same configurations as those shown in FIGS. 1 to 21 and a description thereof may be omitted.

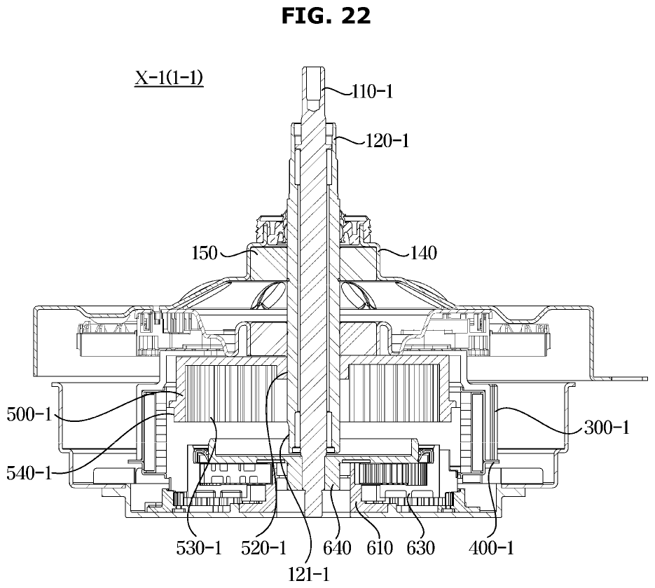

FIG. 22 is a cross-sectional view of a washing machine 1-1 according to an embodiment of the disclosure.

A rotating device X-1 according to an embodiment of the disclosure will be described with reference to FIG. 22.

The washing machine 1 may include the rotating device X.

According to an embodiment described with reference to FIGS. 1 to 21, the coupler 500 may be connected to the ring gear 630 and the spin-drying shaft 120 when the washing machine 1 is in the washing operation.

According to an embodiment described with reference to FIG. 22, a coupler 500-1 may be prevented from being connected to a ring gear 630-1 and a spin-drying shaft 120-1 when the washing machine 1-1 is in the washing operation.

A first position of the coupler 500-1 may be located higher than that according to an embodiment described with reference to FIGS. 1 to 21.

When the coupler 500-1 is located in the first position, the coupler 500-1 may be located above the ring gear 630-1.

When the coupler 500-1 is located in the first position, the coupler 500-1 may be located above a spin-drying toothed member 121-1.

When the coupler 500-1 is positioned in the second position, the coupler 500-1 may be engaged with the ring gear 630-1. When the coupler 500-1 is located in the second position, the coupler 500-1 may be engaged with the spin-drying toothed member 121-1.

The rotating device X-1 in the embodiment described with reference to FIG. 22 may include the spin-drying shaft 120-1 and a washing shaft 110-1 that are longer than the rotating device X in the embodiment described with reference to FIGS. 1 to 21. The rotating device X-1 in the embodiment described with reference to FIG. 22 may include a support bracket 300-1 and a coupler lifting device 400-1 that are longer than the rotating device X in the embodiment described with reference to FIGS. 1 to 21.

That is, the coupler 500-1 may be disengaged from the spin-drying shaft 120-1, the ring gear 630-1, and the rotor 210-1 while the washing machine 1-1 performs the washing operation.

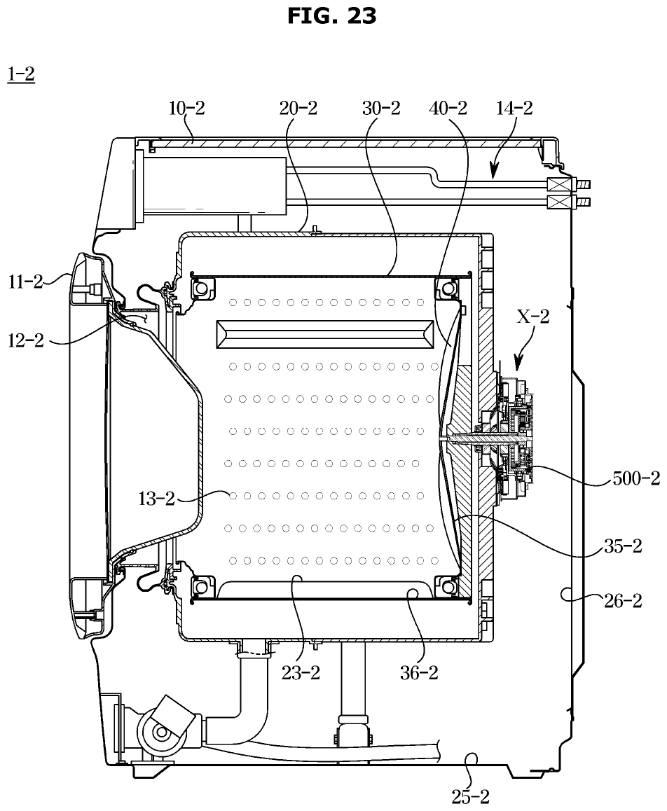

FIG. 23 is a cross-sectional view of a washing machine 1-2 according to an embodiment of the disclosure.

The washing machine 1-2 according to an embodiment of the disclosure will be described with reference to FIG. 23.

The embodiment described with reference to FIGS. 1 to 21 has been described with the assumption that the washing machine 1 is the top-loading type.

An embodiment described with reference to FIG. 23 will be described with an assumption that the washing machine 1-2 is the front-loading type.

The front-loading washing machine 1-2 will be described.

A door 11-2 configured to open and close an inlet 12-2 is provided on one side of a case 10-2. The door 11-2 may be provided on the same surface as the inlet 12-2 and may be rotatably mounted to the case 10-2 by a hinge.

A tub 20-2 may be provided inside the case 10-2. The tub 20-2 may contain water for washing or rinsing laundry.

The tub 20-2 may include a substantially circular bottom surface 25-2 of the tub 20 and a sidewall 26-2 of the tub 20-2 provided along a circumference of the bottom surface 25-2 of the tub 20. An opening may be formed on a surface facing the bottom of the tub 20-2 to allow laundry to be put in or taken out.

As for the front-loading washing machine 1-2, the tub 20-2 may be arranged in such a way that the bottom surface 25-2 of the tub 20 faces the rear of the washing machine 1-2 and a central axis of the side wall 26-2 of the tub 20-2 is substantially parallel to the floor.

The drum 30-2 may be configured to be rotated inside the tub 20-2.

The drum 30-2 may receive laundry. For example, the drum 30-2 may have a cylindrical shape with one bottom surface open. The drum 30-2 may include a substantially circular bottom surface 35-2 of the drum 30-2, and a side wall 36 of the drum 30-2 provided along a circumference of the bottom surface 35-2 of the drum 30-2. The other bottom surface of the drum 30-2 may include an opening to allow laundry to be put into or taken out of the drum 30-2.

As for the front-loading washing machine 1-2, the drum 30-2 may be arranged in such a way that the bottom surface 35-2 of the drum 30-2 faces the rear of the washing machine 1-2 and a central axis of the side wall 36-2 of the drum 30-2 is substantially parallel to the floor, as shown in FIG. 1.

A spin-drying hole 13-2 provided to connect an inside and an outside of the drum 30-2 may be provided on the side wall 36-2 of the drum 30-2 to allow water, which is supplied from the tub 20-2, to flow into the inside of the drum 30-2.

As for the front-loading washing machine 1-2, a lifter 23-2 for lifting laundry to the upper side of the drum 30-2 in the rotation of the drum 30-2 may be provided on the side wall 36-2 of the drum 30-2, as shown in FIG. 1.

A water supplier 14-2 may supply water to the tub 20-2 and the drum 30-2. The above-mentioned front-loading washing machine 1-2 may include a rotating device X-2 arranged at the rear side.

The front loading-washing machine 1-2 may also include a pulsator 40-2.

The rotating device X-2 includes the same configuration as in FIGS. 1 to 21, except that a position of the rotating device X-2 is rotated by 90 degrees.

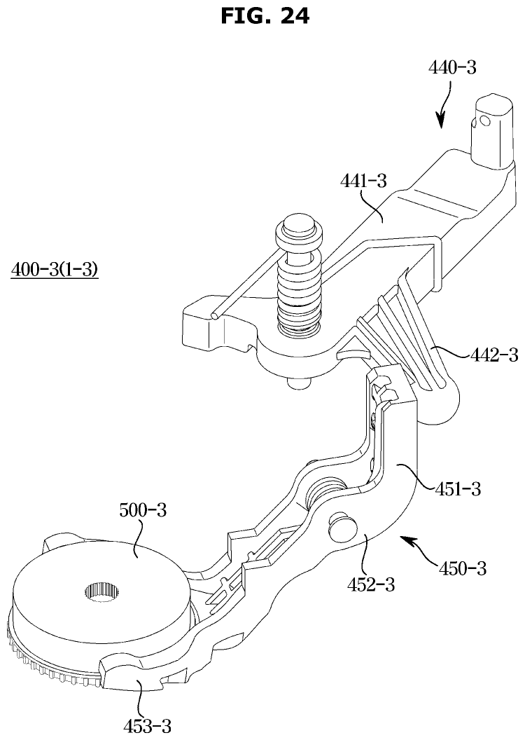

FIG. 24 is a perspective view illustrating a coupler lifting device 400-3 of a washing machine 1-3 according to an embodiment of the disclosure.

The coupler lifting device 400-3 according to an embodiment of the disclosure will be described with reference to FIG. 24.

The coupler lifting device 400 according to the embodiment described with reference to FIGS. 1 to 21 is a device that changes the position of the coupler 500 using electricity or magnetism.

The coupler lifting device 400-3 according to an embodiment is a device that changes a position of the coupler 500-3 by a physical action.

The coupler lifting device 400-3 may include a first lever 440-3 and a second lever 450-3.

The first lever 440-3 may be configured to pivot in the left and right directions.

The first lever 440-3 may include a rotation axis extending in the vertical direction.

The first lever 440-3 may include a lever body 441-3.

The first lever 440-3 may include a lever protrusion 442-3 extending from the lever body 441-3.

The lever protrusion 442-3 may protrude from a lateral portion of the lever body 441-3 toward the lateral side.

The second lever 450-3 may include a lever contact member 451-3 provided to be in contact with the lever protrusion 442-3.

The lever contact member 451-3 may extend in the vertical direction.

The second lever 450-3 may include a lever coupling member 453-3 hinged with the coupler 500-3.

The second lever 450-3 may include a lever extension 452-3 connecting the lever contact member 451-3 and the lever coupling member 453-3.

The lever extension 452-3 may be configured to pivot.

The first lever 440-3 may be rotated in the left and right direction. As the first lever 440-3 is rotated, the lever protrusion 442-3 of the first lever 440-3 may press and move the lever contact member 451-3 of the second lever 450-3.

Due to the movement of the lever contact member 451-3, the lever extension 452-3 may be rotated and moved.

Due to the rotation of the lever extension 452-3, the lever coupling member 453-3 may move the coupler 500-3 to a first position or a second position.

The coupler lifting device 400-3 may be configured to pivot to press the coupler 500-3 so as to move the coupler 500-3 to a position spaced apart from the rotor 210-3.

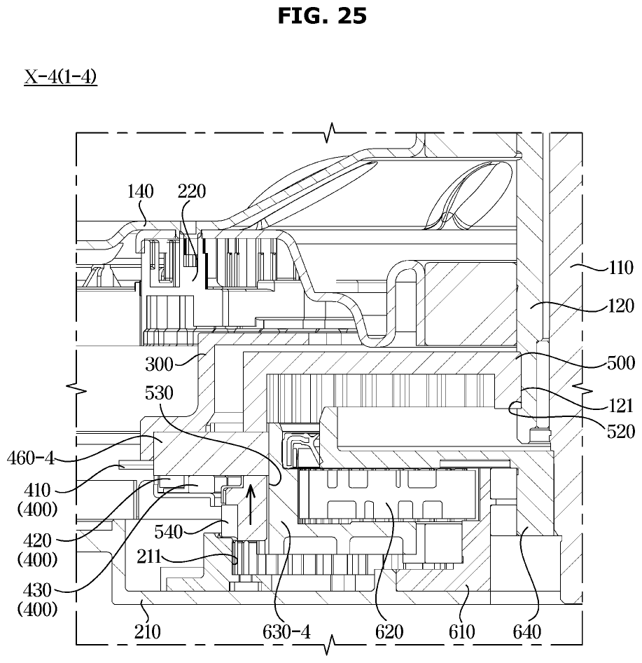

FIG. 25 is a cross-sectional view illustrating a rotating device X-4 of a washing machine 1-4 according to an embodiment of the disclosure.

The rotating device X-4 according to an embodiment of the disclosure will be described with reference to FIG. 25.

The rotating device X-4 may include a brake 460-4. The brake 460-4 may be in contact with a ring gear 630-4.

The ring gear 630-4 needs to be fixed when the washing machine 1-4 performs the washing operation. For this, the brake 460-4 may be configured to limit the movement of the ring gear 630-4.

The brake 460-4 may come into contact with the ring gear 630-4 when the washing machine 1-4 performs the washing operation.

The brake 460-4 may release the contact with the ring gear 630-4 when the washing machine 1-4 performs the spin-drying operation.

As is apparent from the above description, a washing machine may prevent an increase in a height by including a coupler or a reduction gear module that are received in a motor assembly.

Further, a washing machine may include a reduction gear module to which a washing shaft is connected, and thus in a washing operation of the washing machine, it is possible to allow the washing shaft to be rotated at a speed necessary for the washing operation even when a motor assembly is rotated at an optimal rotational speed.

Further, because a reduction gear module is received in a coupler and received in a motor assembly, it is possible to prevent an increase in a height of a washing machine even when the coupler and the reduction gear module are located inside the motor assembly.

Further, a washing operation and a spin-drying operation may be smoothly switched because a coupler is moved from a first position, in which the coupler is disconnected from a rotor, to a second position in which the coupler is connected to the rotor.

Further, a coupler may be connected to a ring gear of a reduction gear module and connected to a rotor, and thus a washing shaft may be rotated at a rotation speed of the rotor. Accordingly, when a washing machine performs a spin-drying operation, the washing shaft may be rotated at the same speed as a spin-drying shaft although the washing machine includes the reduction gear module.

Further, a washing machine may include a coupler lifting device that changes a magnetic field by a solenoid, and a coupler may include a yoke interacting with the magnetic field, thereby allowing the coupler to move.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A washing machine comprising:
a tub;
a drum rotatable inside the tub;
a pulsator rotatable inside the drum;
a motor assembly, including a rotor, to supply a driving force;
a reduction gear module couplable to the rotor of the motor assembly so that while at least a portion of the reduction gear module is coupled to the rotor, the at least a portion of the reduction gear module is rotatable at an angular velocity that is less than an angular velocity at which the rotor is rotated based on the driving force of the motor assembly;
a washing shaft couplable to the pulsator and couplable to the portion of the reduction gear module so that while the washing shaft is coupled to the pulsator and the portion of the reduction gear module, the pulsator is rotatable at an angular velocity that is less than the angular velocity at which the rotor is rotated based on the driving force of the motor assembly;
a spin-drying shaft couplable to the drum so that while the spin-drying shaft is coupled to the drum, the drum is rotated; and
a coupler couplable to the spin-drying shaft and the rotor so that while the coupler is coupled to the spin-drying shaft and the rotor, the spin-drying shaft is rotatable at the angular velocity at which the rotor is rotated based on the driving force of the motor assembly,
wherein the coupler includes a coupler body having a receiving space to receive the reduction gear module.

2. The washing machine of claim 1,
wherein the motor assembly includes a mounting space to receive the coupler while the reduction gear module is received in the receiving space of the coupler.

3. The washing machine of claim 1,
wherein the reduction gear module is located between the coupler and the rotor.

4. The washing machine of claim 2,
wherein the washing machine is configured to perform a washing operation and a spin-drying operation,
wherein the coupler comprises:
a first toothed member to be engaged with the spin-drying shaft in the spin-drying operation of the washing machine;
a second toothed member to be engaged with the reduction gear module in the spin-drying operation of the washing machine; and
a third toothed member to be engaged with the rotor in the spin-drying operation of the washing machine.

5. The washing machine of claim 4, wherein the coupler is configured to be moved between:
a first position, in which the third toothed member is spaced apart from the rotor to limit a rotation of the spin-drying shaft while the washing machine performs the washing operation, and
a second position, in which the third toothed member is engaged with the rotor to rotate the spin-drying shaft while the washing machine performs the spin-drying operation.

6. The washing machine of claim 5, wherein the reduction gear module includes:
a sun gear couplable to the rotor and configured to be rotated by the rotor;
a plurality of pinion gears to be engaged with the sun gear to be rotated around the sun gear;
a ring gear to surround the plurality of pinion gears and be engaged with the plurality of pinion gears to be rotated with the plurality of pinion gears, the ring gear including a ring toothed member configured to be engaged with the second toothed member; and
a carrier couplable to a rotation axis of each of the plurality of pinion gears, and couplable to the washing shaft to be rotated together with the washing shaft.

7. The washing machine of claim 6,
wherein the coupler is couplable to the spin-drying shaft coupled to the drum and the ring gear to limit movement of the ring gear while the washing machine performs the washing operation.

8. The washing machine of claim 6, wherein,
while the washing machine performs the spin-drying operation,
the coupler is rotated at a speed at which the rotor is rotated;
the ring gear is rotated with the coupler as the coupler is rotated; and
the spin-drying shaft and the washing shaft are rotated at a speed at which the ring gear and the carrier are rotated.

9. The washing machine of claim 8, wherein
the second toothed member is located inside the coupler body to allow the ring gear to be received in the receiving space.

10. The washing machine of claim 9, wherein
the third toothed member is positioned outside the coupler body to be engaged with the rotor on an outside of the coupler body while the washing machine performs the spin-drying operation.

11. The washing machine of claim 9, wherein
the first toothed member extends along the spin-drying shaft from the coupler body to increase a contact area between the coupler and the spin-drying shaft.

12. The washing machine of claim 4,
wherein the spin-drying shaft comprises a spin-drying toothed member configured to be engaged with the first toothed member;
wherein the reduction gear module comprises a ring toothed member configured to be engaged with the second toothed member;
wherein the rotor comprises a rotor toothed member configured to be engaged with the third toothed member,
wherein the spin-drying toothed member is located closer to the drum than the ring toothed member;
wherein the rotor toothed member is located farther from the drum than the ring toothed member;
wherein the coupler is configured to be at a first position while the washing machine performs the washing operation, the first toothed member is coupled to the spin-drying toothed member, the second toothed member is coupled to the ring toothed member, and the third toothed member is disengaged from the rotor toothed member; and
wherein the coupler is configured to be at a second position, which is farther from the drum than while the coupler is at the first position, while the washing machine performs the spin-drying operation, the first toothed member is coupled to the spin-drying toothed member, the second toothed member is coupled to the ring toothed member, and the third toothed member is coupled to the rotor toothed member.

13. The washing machine of claim 12, further comprising:
a solenoid configured to emit a magnetic field,
wherein the coupler comprises a yoke configured to interact with the magnetic field emitted by the solenoid; and
wherein the coupler is configured to be moved between the first position and the second position according to the magnetic field emitted by the solenoid.

14. The washing machine of claim 13, further comprising:
a permanent magnet positioned adjacent to the solenoid, and configured to, in response to the coupler being in the second position, limit movement of the coupler.

15. The washing machine of claim 6, wherein:
the reduction gear module includes:
a first gear bearing configured to support the sun gear and the ring gear to allow the sun gear and the ring gear to be rotated independently of each other; and
a second gear bearing configured to support the sun gear and the carrier to allow the sun gear and the carrier to be rotated independently of each other.
